(19) United States
(12) Patent Application Publication
(10) Pub. No.: US 2007/0028769 A1
(43) Pub. Date: Feb. 8, 2007

(54) Method and apparatus for producing potable water from air including severely arid and hot climates

(76) Inventors: Dustin M. Eplee, Schwenksville, PA (US); Mark M. Graybill, Mount Joy, PA (US)

Correspondence Address: GIFFORD, KRASS, GROH, SPRINKLE & CITKOWSKI, P.C, PO BOX 7021, TROY, MI, 48007-7021, US

(21) Appl. No.: 11/198,771

(22) Filed: Aug. 5, 2005

(51) Int. Cl. B01D 53/06

(52) U.S. Cl. 95/113

(57) ABSTRACT

Methods and apparatus for extracting liquid water from ambient air, including ambient air in severely arid and hot climates, are described. An example apparatus uses a sorption-desorption-condensation cycle using a sorption wheel to extract moisture from ambient air and concentrate the water vapor driven off from the sorption material in a circulating gas, with condensation of liquid water from the circulating gas.

### FIELD OF THE INVENTION

The invention relates to the production of liquid water, and more particularly relates to apparatus and methods for the production of potable water by extraction of water vapor from air, including air from an extremely arid and hot atmosphere.

### BACKGROUND OF THE INVENTION

All life depends on water. The mere existence of the living world including plants, animals, and humans would be unthinkable without the nourishment of clean, abundant water. A great majority of the earth is blanketed with dry, arid climates. Clean water shortages embody a worldwide humanitarian crisis with predictions of increasing populations putting additional strain on already depleted natural water resources. Traditional means of meeting this demand are falling short. Hence, there is a need for new, economical devices and methods that can reliably produce significant quantities of potable water to areas needing it the most; often extremely arid regions.

One promising solution to the world's growing thirst for this life-sustaining liquid is a method for direct extraction of water from the atmosphere. The idea of reducing atmospheric water vapor into liquid has been practiced through the art of cloud seeding since the 1940s.

However, methods and devices disclosed in the prior art are either not conducive to operation in arid climates, and/or are not suitable for reliable production of potable water in significant quantities, and/or cannot be implemented in compact portable units, and/or require large amounts of energy per quantity of water produced.

Hence, there is a need for new devices and methods that can reliably produce significant quantities of potable water in areas needing it the most; often extremely arid regions. As will become evident, nothing in the prior art provides the benefits and advantages offered by embodiments of the present invention.

### SUMMARY OF THE INVENTION

An example apparatus for producing liquid water from water vapor in a source gas comprises a flow path through which the source gas flows, a recirculating flow configuration through which a circulating gas flows, and a moisture transfer device, transferring the water vapor from the source gas to the circulating gas. The recirculating flow configuration includes a condenser and a heater, the condenser cooling the circulating gas so that the liquid water condenses from the water vapor in the circulating gas, and the heater heating the circulating gas to increase water vapor uptake from the moisture transfer device. The recirculating flow configuration may also include a condenser bypass, a fraction of the circulating gas passing through the condenser bypass, with the remainder passing through the condenser. Other cooling devices may be included within the recirculating flow configuration. The fraction of the circulating gas passing through the condenser bypass may be adjustable, for example as a function of ambient humidity or moisture uptake of the circulating gas.

The moisture transfer device may comprise a hygroscopic element such as a sorption wheel, comprising one or more hygroscopic materials such as lithium chloride, silica gel, calcium chloride, other inorganic salts, zeolites, molecular sieves, other hygroscopic materials (or desiccants), or other materials.

The source gas can comprise atmospheric (ambient) air, such as outdoor atmospheric air in an arid environment. The source gas may comprise evaporation from bodies of water, animal or human exhalations, combustion products (such as vehicle exhaust gases), or other sources of water vapor, and may comprise air taken from a building or vehicle interior, vehicle exhaust, other combustion products, or air humidified by passing over or through water. The circulating gas may comprise air, or other gas chosen to take up moisture from the moisture transfer device. The apparatus may further comprise a water sterilizer, such as a bacterial killing device comprising a UV radiation source, heater, chemical agent, or some combination of pathogen killing materials or treatments.

Apparatus according to embodiments of the present invention can be configured so as to be entirely powered by solar energy, for example using a solar heater and one or more fans powered by a photovoltaic device or devices.

Apparatus according to embodiments of the present invention may be supported by a vehicle, and used as a source of engine cooling. Apparatus may also be in the form of portable devices carried by a person.

Liquid water produced by apparatus according to embodiments of the present invention may further be used in cooling applications, for example to cool engines, as an air conditioner, or as a freezer. Such devices may be entirely powered by solar energy.

A method of producing liquid water from water vapor in air in an arid environment comprises: extracting water vapor from a flow of a source gas (such as air) using a sorption wheel; transferring the water vapor to a circulating gas (such as air) within a recirculating flow configuration, for example by rotating the sorption wheel so that moisture absorbed by the sorption wheel is exposed to the circulating gas; condensing the liquid water from the circulating gas using one or more cooling devices, such as a condenser; and then heating the circulating gas and recirculating the circulating gas over the sorption wheel. The method may further comprise sterilizing the liquid water for human consumption.

Other embodiments of the invention will be readily apparent to those skilled in the art from the following description taken in conjunction with the claims and accompanying drawings.

### BRIEF DESCRIPTION OF THE DRAWINGS

FIG. 1 is a perspective view of a closed-cycle apparatus to generate water from air including severely dry air in accordance with a first embodiment of the subject invention utilizing a sole heat source;

FIG. 2 is a schematic illustration of a closed-cycle, condensate-producing apparatus with condenser bypass for improved energy consumption in accordance with a first embodiment of the subject invention utilizing a single heat source;

FIG. 3 is a simplified psychrometric chart illustrating the change of conditions of the air or gas as it moves through the system of FIG. 2;

FIG. 4 is a schematic illustration depicting the method of water generation for the first embodiment;

FIG. 5 is a schematic illustration using a closed loop without condenser bypass, solar energy principle heat, boaster heat backup, no internal heat exchanger, and a single fan to move air through a single open loop;

FIG. 6 is a schematic illustration using a single open loop coupled to a closed-cycle loop with variable condenser bypass;

FIG. 7 is a schematic illustration of an alternative first embodiment using two open loop paths with a common fan powering them;

FIG. 8 is a schematic illustration of an alternative first embodiment utilizing combined heat and power;

FIG. 9 is a schematic illustration of an alternative first embodiment using a split closed loop path with dampers to control airflow between regeneration and condensation;

FIG. 10 is a perspective view of an apparatus to generate water from severely hot, dry air in accordance with a second embodiment of the subject invention utilizing a refrigeration cycle and providing potable water for various uses;

FIG. 11 is a schematic illustration of a second embodiment with condenser bypass for improved energy consumption in accordance with a first embodiment of the subject invention utilizing a split system refrigeration cycle;

FIG. 12 is a simplified psychrometric chart illustrating the change of conditions of the air or gas as it moves through the system of FIG. 11;

FIG. 13 is a schematic illustration of the relationship between various refrigeration cycle components;

FIG. 14 is a variant of a second embodiment with the removal of condenser bypass, internal heat exchanger, and second open loop;

FIG. 15 is a variant of a second embodiment using a single open loop powered by one fan and without open loop heat exchanger;

FIG. 16 is a schematic illustration of an alternative second embodiment using two open loop paths with a common fan powering them;

FIG. 17 is a perspective view of a closed-cycle, portable apparatus to generate water from air including severely dry air in accordance with a third embodiment of the subject invention utilizing an enclosure capable of easy transport via a human back;

FIG. 18 is a schematic illustration of a third embodiment with the intention of easy transport;

FIG. 19 is a schematic illustration of a third embodiment without a closed-loop heat exchanger;

FIG. 20 is a perspective view of a closed-cycle apparatus to generate water from air in accordance with a fourth embodiment of the subject invention utilizing waste heat from a motor vehicle;

FIG. 21 is a perspective view of adaptation of a fourth embodiment to the underside of an automobile;

FIG. 22 is a schematic illustration of a fourth embodiment coupled to the waste heat of an automobile;

FIG. 23 is a perspective view of a closed-cycle apparatus to generate water from air in accordance with an alternative to a fourth embodiment of the subject invention utilizing waste heat from a radiator;

FIG. 24 is a perspective view of adaptation of an alternative fourth embodiment coupled to a motor vehicle radiator;

FIG. 25 is a schematic illustration of a closed-cycle apparatus to filter water in accordance with a fifth embodiment of the subject invention utilizing a sole heat source and evaporative device;

FIG. 26 is a simplified psychrometric chart illustrating the change of conditions of the air or gas as it moves through the system of FIG. 25;

FIG. 27 is a schematic illustration of a fifth embodiment using heat from the sun to reactivate a sorption wheel and solar voltaic cells to power the fans in order to filter and distill water;

FIG. 28 is a schematic illustration of an alternative fifth embodiment using a closed loop regenerative path coupled with dampers for the option to accept and release air within the system;

FIG. 29 is a schematic illustration of an alternative fifth embodiment using a closed loop regenerative path coupled with dampers for the option to accept and release air located before the heating device;

FIG. 30 is a perspective view of a dual, closed-cycle apparatus to provide cooling of an air stream in accordance with a sixth embodiment of the subject invention utilizing an evaporative device with complete water recovery running solely with heat and fan energy;

FIG. 31 is a schematic illustration of a dual, closed-cycle apparatus to provide cooling of an air stream in accordance with a sixth embodiment of the subject invention utilizing an evaporative device with complete water recovery running solely with heat and fan energy;

FIG. 32 is a simplified psychrometric chart illustrating the change of conditions of the air or gas as it moves through the system of FIG. 30;

FIG. 33 is a schematic illustration of two cooling devices according to a seventh embodiment linked together to produce colder temperatures to produce refrigeration or freezer temperatures;

FIG. 34 is a schematic illustration of an alternative seventh embodiment closed-loop coupled to an open loop evaporative device to provide cooling of an air stream; and

FIG. 35 is a schematic illustration of a combination of a water generating apparatus coupled to a cooling apparatus, providing the ability to produce potable water in extremely hot and extremely arid climates with operation powered solely by the sun.

The same reference numerals refer to the same parts throughout the various figures.

### DETAILED DESCRIPTION OF THE INVENTION

Embodiments of the present invention include apparatus and methods for extracting potable water from ambient air, including severely arid and hot climates. An example apparatus according to the present invention is based on a sorption-desorption-condensation cycle using a sorption wheel to extract moisture from ambient air and concentrate the water vapor driven off from the sorption material with subsequent heating followed by condensation.

Embodiments of the present invention include methods and apparatus for extracting potable water from ambient air, including severely arid climates with the ability for autonomous operation. Embodiments use a sorption-desorption-condensation cycle using a sorption wheel to extract moisture from ambient air and concentrate the water vapor driven off from the sorption material in a circulating gas, with heating followed by condensation of liquid water from the circulating gas.

An example apparatus for obtaining potable water from the atmosphere includes two closed-loop regenerative air paths realizing extremely high dew point temperatures, allowing for water generation in extremely arid climates and increasing energy efficiency by decreasing condenser energy losses.

A further example apparatus includes four distinct air paths: (1) a first path, an open path having an input end, into which a source of water vapor enters, and an output end, with a first fan to drive a first air flow from the input end to the output end; (2) a second path, a closed loop path including a second fan for continuously moving a second air flow around the closed-loop path, and including a heating device; (3) a third path, a closed-loop path sharing the second fan with the second path, but having an independent, adjustable flow rate control and having a plurality of temperature changing devices purposed to condense moisture from the third air flow, such as a pre-cooling condenser device, a cooling condenser device, and a reheating device coupled to the pre-cooling condenser device, and (4) a fourth path, an open path for providing ambient condensing to the third air path, having an input end and an output end with a third fan. A sorption wheel is used to transfer moisture from the first flow of air to the second flow of air, with a motor to rotate the wheel in a continuous path of travel through first air flow and second air flow.

A common condenser bypass between the second path and the third path realizes extremely high dew point temperatures, allows for water generation in extremely arid climates, and increases energy efficiency by decreasing condenser energy losses. A bacteria killing heated sorption rotor, closed-loop air paths, and/or ultraviolet light serve as protection against the susceptibility of growing microorganisms. Large airflow and sorption wheel exposure area ratios between first air path and second air path allow for a greater sorption of moisture from extremely arid climates, greater water flows, and higher energy efficiency. Embodiments of the present invention can operate autonomously using low temperature energy sources in the form(s) of solar heat, solar voltaic, geothermal, wind turbine, engine exhaust, or other form of waste heat. The apparatus can be tailored in size, and therefore, output capacity. Embodiments vary from a human carried backpack unit, to automobile adaptability, to full-scale industrial city plants.

Depending on atmospheric conditions and the configuration of a given embodiment of the present invention, water can be generated in one or more locations within an apparatus. For example, liquid condensate may form on a heat exchanger before and after the condenser, on a heat exchanger with the ambient air, on a mechanically cooled evaporator coil located in the closed loop, on a mechanically cooled evaporator coil located in the open loop, or on any cooling element. Additional means of purifying condensate surfaces can be used, including but not limited to ultraviolet light, chemical agents, or ozone cleaning.

Liquid condensate produced is collected and delivered by gravity or pumps for a variety of uses. In a first use, the water is transported or stored for the ultimate consumption of humans, plants or animals. In a second use, the condensate is adiabatically sprayed to produce a cooling effect. This can be performed in two separate closed cycle loops, providing cooling of air without an external supply of water. This embodiment represents an alternative to traditional absorption chillers with both operating and maintenance costs lower than previously realized.

One advantage of using an embodiment of the present invention over existing methods of liquid extraction from atmospheric air is it can economically produce significant quantities of potable water even in absolute humidity conditions below six (6) grains of water vapor per pound of dry air (0.000857 lbv/lba). An example apparatus can operate in relative humidity levels below five percent (5%). Potable water generation continues even in ambient temperatures well below freezing. With the addition of a sorption rotor air conditioner, such as discussed in the seventh embodiment below, economical water generation results even from ambient temperatures greater than 120° F. (49° C.). Traditional split-system refrigeration technology can also be used.

Potable water can be realized through the most efficient use of energy resources available to a specific geography, climate, and culture. Energy, for example to help provide heating, cooling, air flow, or other purpose, may originate from a variety of forms including, but not limited to, solar heat, solar voltaic, electric grid, fossil fuel, geothermal, wind turbine, a vehicle engine, cogeneration exhaust heat, vehicle motion, human or animal activity, coal, organic burning, or any form of waste heat.

Alternative uses include an agriculture watering source and livestock watering stations. Another alternate application is potable water production for domestic uses such as individual residential households. Yet another alternate application is to couple an apparatus according to the present invention to the waste heat generated off of a truck, automobile, train, plane, or other mobile transportation whereby allowing for free generation of purified water while in transit.

The invention can be practiced in several embodiments. In a first embodiment of the subject invention, a heat source is applied within a closed loop to provide potable water generation even in extremely arid climates. Different approaches to conveying heat to the sorption material can be used, including solar heating.

In a second embodiment of the subject invention, a split-system refrigeration cycle is used to provide the heat for desorption of water vapor from sorption medium while incoming ambient air is pre-cooled to encourage absorption to the sorption medium even in extremely hot and arid climates. The number of sorption wheels, sorption material configuration, number of heat exchangers, and placement of the evaporator coils can be adjusted. A low reactivation temperature, lithium chloride desiccant wheel is identified to allow for successful condenser heat rejection from readily available refrigeration equipment. Conventional refrigerants can be used.

In a third embodiment of the invention, a scaled down apparatus is described allowing some degree of portability. An apparatus can be pulled, carried, or otherwise moved by a human, animal, or vehicle. An apparatus can supply potable water to a human as the human moves through an arid environment. Variants include possible autonomous operation using fossil fuels, solar heat, solar voltaic, and batteries.

In a fourth embodiment of the invention, an apparatus according to the present invention is used in a truck, automobile, train, plane, or other form of motorized transportation, using the waste heat delivered by the vehicle engine, for example through an exhaust pipe.

In a fifth embodiment of the invention, example apparatus are described that use heat rejected by a vehicle radiator, or other source of heat. Apparatus may replace conventional vehicle cooling systems.

In a sixth embodiment of the invention, a distilled water-producing path is coupled with an evaporative method. This embodiment serves as a filter with potentially unsafe or dirty water being transformed into pure, safe potable water. Both open and closed variants are identified.

In a seventh embodiment of the invention, a means of cooling an air stream with heat and fan energy is disclosed. A dual-loop, closed cycle system with liquid condensate back fed into a separate loop to produce cooling can be used to replace conventional absorption chillers with lower costs and lower energy input. An open cycle cooling system is discussed for humid climates. The adiabatic sprayer can be coupled with a closed-cycle water generation system for autonomous operation in locations where water is not readily available. All variants of the embodiment can be solely operated with heat produced from the sun using a low reactivation temperature lithium desiccant wheel. Embodiment can be combined with any of the previously mentioned variations to provide inlet pre-cooling and produce water even in very hot climates.

Apparatus and methods according to the present invention may include additional means of purifying the liquid water condensate. Vertical orientation of condensing devices can be used for a simplified removal of the liquid condensate.

The flow of source gas, the first path air flow, can be increased to more effectively saturate the sorption wheel. A larger percentage of the sorption wheel can be within the open ambient air stream for improved operation in extremely arid climates. Apparatus can be configured for autonomous operation, with heat being generated by the sun and electrical fans driven by photovoltaic cells. The area of the sorption wheel exposed to the flow of source gas (such as ambient air) may be substantially greater than the area exposed to the circulating gas, from which liquid water is condensed.

A low reactivation temperature lithium chloride (LiCl) desiccant wheel is capable of operating with temperatures between 104° F. and 158° F., which can be generated from the sun. Hence, no external energy source is required, allowing the apparatus to be deployed in remote desert areas.

An example apparatus according to the present invention comprises four flow paths: (1) a first path, an open flow path for a source of water vapor having an input end and an output end and including a first fan to drive a first air flow through the first path; (2) a second path, a closed-loop path including a second fan for continuously moving a second air flow around the second path, and including a heater; (3) a third path, a closed-loop path sharing the second fan with the second path, but having independent, adjustable flow rate control and with a one or more temperature changing devices purposed to condense moisture from the third air flow, such as a pre-cooling condenser device, a cooling condenser device, and a reheating device coupled to the pre-cooling condenser device; and (4) a fourth path, an open path for providing ambient condensing to the third air path, having an input end and an output end with a third fan. A common condenser bypass between the first and second flow paths realizes extremely high dew point temperatures, allows for water generation in extremely arid climates, and increases energy efficiency by decreasing condenser energy losses.

A bacterial killing heated sorption rotor, closed-loop air paths, and ultraviolet light serve as protection against the susceptibility of growing microorganisms. Large airflow and sorption wheel exposure area ratios between first air path and second air path allow for a greater sorption of moisture from extremely arid climates, greater water flows, and higher energy efficiency. Embodiments of the present invention can autonomously operate utilizing low temperature energy sources in the form(s) of solar heat, solar voltaic, geothermal, wind turbine, engine exhaust, or other form of waste heat. The apparatus can be tailored in size, and therefore, output capacity. Embodiments vary from a human carried backpack unit, to automobile adaptability, to full-scale industrial city plants.

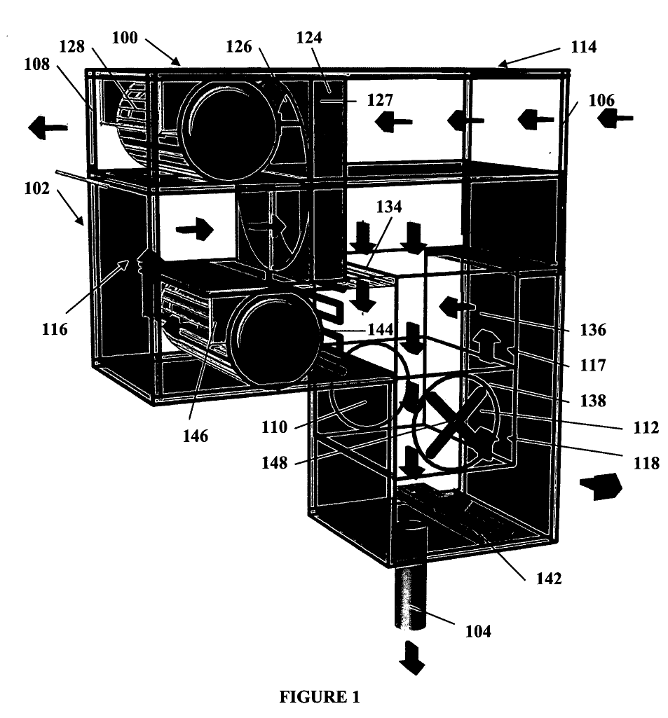

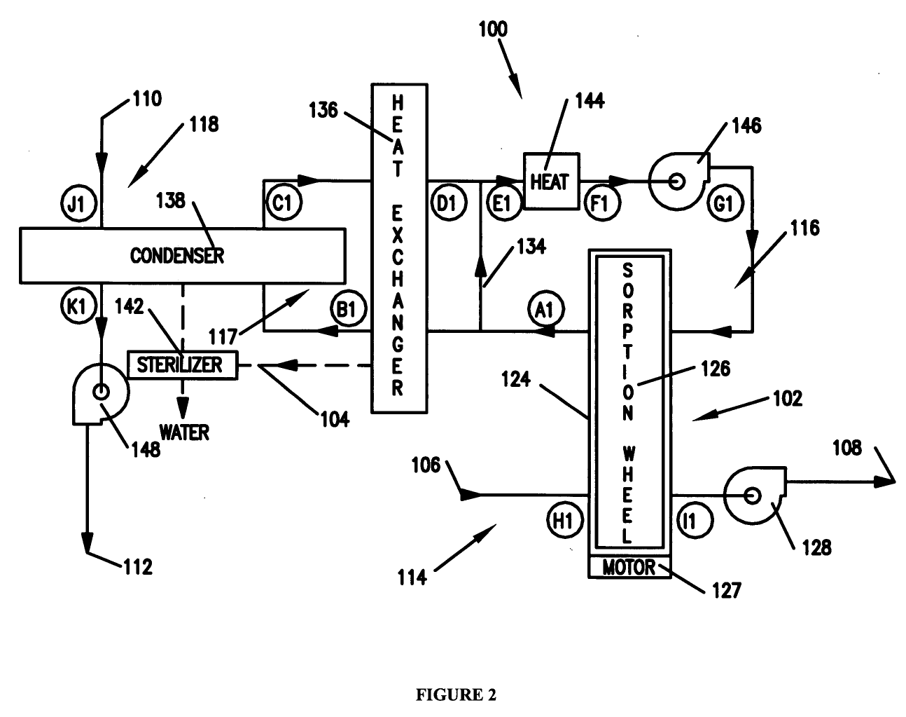

### DESCRIPTION OF A FIRST EMBODIMENT (FIGS. 1-2)

FIGS. 1 and 2 illustrate an apparatus 100 that produces potable water from air in accordance with a first embodiment of the subject invention, and is capable of delivering water even in extremely arid atmospheric conditions. FIG. 1 is shows a view of the apparatus, and FIG. 2 is a schematic.

Apparatus 100 comprises water source assembly 102 and water delivery 104. Water source assembly 102 comprises ambient air intake 106, dry ambient air exhaust 108, condenser air intake 110, and condenser air exhaust 112. Water source assembly 102 further houses four separate air paths: (1) a first path 114, an open path for a source of water vapor, (2) a second path 116, a closed-loop regenerative air path, (3) a third path 117, a closed-loop condensing air path, and (4) a fourth path 118, an open ambient air path. The first path 114 comprises a first portion of wheel housing 124 containing sorption material 126, driven by sorption material motor 127, and fan 128. The second path, closed-loop air path 116, comprises a second portion of wheel housing 124 containing sorption material 126, condenser bypass 134, heat source 144, and fan 146. The third path, closed-loop air path 117, comprises condenser bypass 134, pre-condenser heat exchanger 136, and condenser heat exchanger 138. The fourth path 118 comprises a portion of condenser heat exchanger 138 and fan 148. A water sterilizer, in the form of bacteria killing device 142, is used to treat the condensed liquid water for human consumption, or other use. In this example, the second path and third path form a recirculating flow configuration, through which a circulating gas (in this example, air), flows.

### OPERATION OF A FIRST EMBODIMENT

With reference now to FIGS. 1 and 2, the first path 114 is integrated for ambient air or gas intake comprising a source of water vapor for production of potable water, which is drawn through outside air intake 106 creating a flow of first path air by means of suction provided by a fan 128 which further forces system input air 106 through a sorption wheel housing 124 containing sorption material 126. This hygroscopic sorption material can be shaped in the form of a wheel 124, which is continuously rotated by a motorized driving mechanism 127. Sorption material 126 can comprise a hygroscopic matrix coated with lithium chloride desiccant to provide very high absorptive and/or adsorptive properties and thus allow extremely low reactivation temperatures to be achieved. Very dry and warmed air after sorption material 126 is pulled by fan 128, which exhausts this air through outlet 108 with a lower absolute humidity level than intake 106.

The second path, closed loop regeneration path 116, is integrated and includes a regeneration fan 146 that pushes the hot and very humid air or gas through the second path. Hot and humid air is drawn by the pull effect of the fan 146 across the sorption wheel housing 124 and through the sorption material 126. This changes the vapor pressure of the desiccant contained in the sorption material 126 rejecting water vapor originating from the first path into the second path. The second path then diverges with a percentage transferred to the third path while remaining flow is re-circulated through condenser bypass 134. Air traveling through a third path is merged together with flow from the second path and subsequently heated.

Heating device 144 may receive heat energy from solar heated hot water, solar heated air, solar voltaic electric heat, fossil fuels, or low-grade/temperature waste heat, or any other source of heat. Fan 146 effects the movement of the airflow and also serves to (sensibly) increase heat further due to the motor and blades being housed within second closed-loop path. In this way, no energy is lost due to inefficiencies in the motor housing. With this point, the cycle starts again and is continuous and is in a closed loop path.

The third path, closed loop condensing path 117, shares a common condenser bypass 134 with the second path. Air is diverted from re-circulating second path into the third path, where fan 146 pushes the very humid air or gas within the third path and through a first condensing heat exchanger 136. A multitude of heat exchanger types could be used herein such as, but not limited to, heat pipes, plate-to-plate, and rotary heat exchangers. The air is pre-cooled with the possibility of reaching a temperature beneath the dew point whereby water precipitates from a vapor to a liquid stage. The flow is then pushed through a condenser 138, a heat exchanger that allows the further cooling of the air or gas to a temperature beneath the dew point through the use of the fourth path 118 at ambient temperature. The pre-cooled air or gas 117 when crossing the condensing heat exchanger 138 condensates the humidity content and this liquid condensate is further purified by bacteria killing device 142 comprising ultraviolet light, ozone, and the like. Liquid water is condensed out of closed loop regeneration path 117, and delivered by condensate tube 104. The third path air stream 117 is now drier than second air stream air or gas 118.

The fourth path, open ambient condensing path 118, is integrated to provide means to condense water through tube 104 without requiring refrigeration or compression techniques. The fourth path includes outside air intake 110, and a flow of fourth path air is created by means of suction provided by a fan 148. Sensibly warmed air after passing through portion of condensing heat exchanger 138 is pulled by fan 148, which exhausts this air through outlet 112.

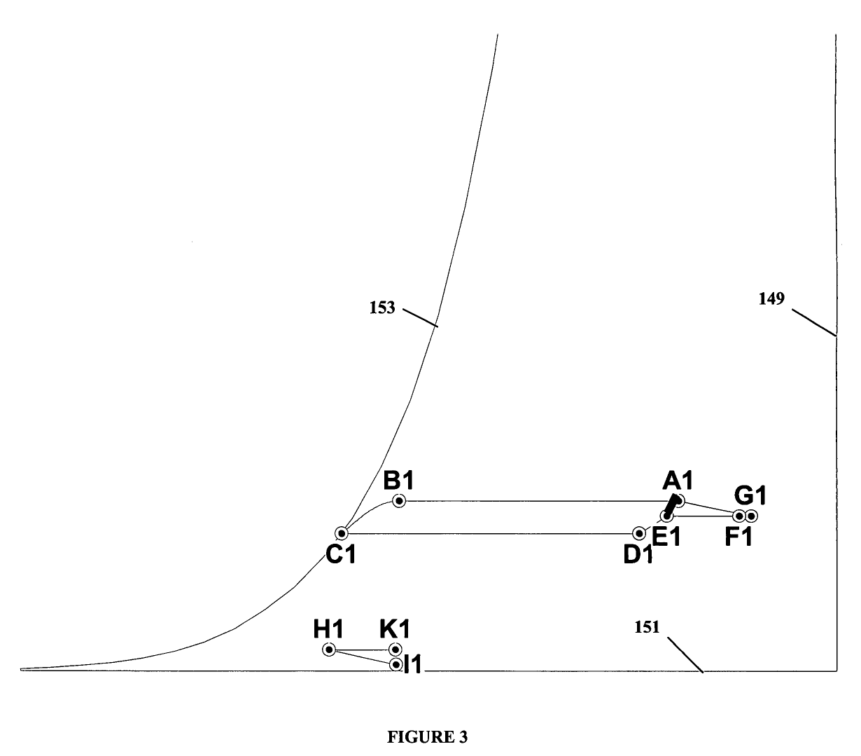

The operation of the apparatus is described further below in relation to alphanumeric references (such as H1), shown in FIG. 2 in circles, which relate to positions on the simplified psychrometric chart of FIG. 3.

The first path 114 constitutes the source of water vapor (H1) which enters apparatus 100 by means of entrance or inlet 106. The first path 114 (H1) is passed through a sorption wheel 124. Water vapor is absorbed and/or adsorbed by sorption material 126 resulting in exhaust ambient air (I1). Water vapor carried by sorption material 126 is rotated by wheel motor 127 into separate, optionally parallel, and second closed-loop air path 116.

Water vapor is desorbed from sorption material by heated, second closed-loop air path (G1). Water vapor is transferred to the second closed-loop air path from the sorption material (A1), and the air stream (A1) is split with a percentage diverted to third closed-loop air path 117 with the remainder continuing through condenser bypass 134, to improve energy efficiency. Third closed-loop air path 117 (B1) is pre-cooled by pre-condenser heat exchanger 136 coupled to the air stream (C1). Water is condensed at ambient temperature from third closed-loop air path 117 (C1) by condenser heat exchanger 138 coupled to condenser ambient air path 118.

Liquid condensate is further purified by bacteria killing device 142. Purified, distilled water is delivered by water delivery 104. Third closed-loop air path 117 (D1) is pre-heated by pre-condenser heat exchanger 138 coupled to air stream (A1). Second closed-loop air path 116 (A1) is split with a percentage continuing through second closed-loop air path 116 via condenser bypass 134 to improve energy efficiency. Air in the condenser by-pass portion of the second closed-loop air path 116 (A1) is mixed with the third closed-loop air path 117 (D1) to produce second closed-loop air path 116 (E1). Second closed-loop air path 116 (F1) is heated by a heat source 144. Fan 146 pushes air through both closed-loop air paths and further increases temperature (G1). Fan 128 pulls water vapor source air 114 through sorption wheel 124 and is exhausted through dry ambient air exhaust 108. A fourth open path 118 carrying ambient air for condensing (Hi) enters apparatus 100 by means of entrance 110. Fan 148 pulls fourth condenser ambient air path 118 through condenser heat exchanger 138 and is exhausted through exhaust 112.

With reference to the FIG. 3, there is shown a simplified psychrometric chart illustrating the thermal processes occurring within the apparatus shown in FIG. 2. In FIG. 3, the vertical axis 149 represents the absolute humidity content of water, weight of moisture per weight of dry air. The horizontal axis 151 represents the sensible temperature, measured in temperature units. The curve line 153 presents the saturation of air or gas, which means 100 percent relative humidity. Referring now to the first path 114, point H1 corresponds to an extremely arid ambient climate where the source of water vapor to produce potable water originates. This ambient air is pulled through the sorption material and the change of vapor pressure causes the sorption material to absorb and/or adsorb almost all the water vapor from the ambient air producing I1 point.

Referring now to the closed loop regeneration second path 116, hot and relatively dry air G1 is pulled through the sorption material and the change of vapor pressure rejects most of the water vapor to the second path air stream. A percentage of the second path is re-circulated and mixed with cooler and drier air at E1 originating from the third path. Re-circulation of the second path realizes higher dew point temperatures, allowing for water generation in extremely arid climates, and increasing energy efficiency by decreasing condenser energy losses. Air or gas is then sensibly heated to point F1 and re-heated by motor and movement of fan 146 to G1, which starts the cycle of the second path again.

Referring now to the closed loop condensing third path 117, warm and very humid air A1 sensibly cooled to point B1 with the possibility of reaching a temperature beneath the dew point whereby water precipitates from vapor to liquid stage. From B1, the third air path is further cooled to a temperature beneath the dew point whereby additional water precipitates from vapor to liquid stage at point C1. Liquid water is further treated and delivered for human consumption or cooling. Now air or gas is cool and with a lower absolute humidity level content than at A1 whereafter the mass of drier air is reheated to D1 and then mixed with closed loop air stream two producing point E1. Referring now the open fourth path 118, point H1 corresponds to ambient climate air where it is sensibly heated to K1.

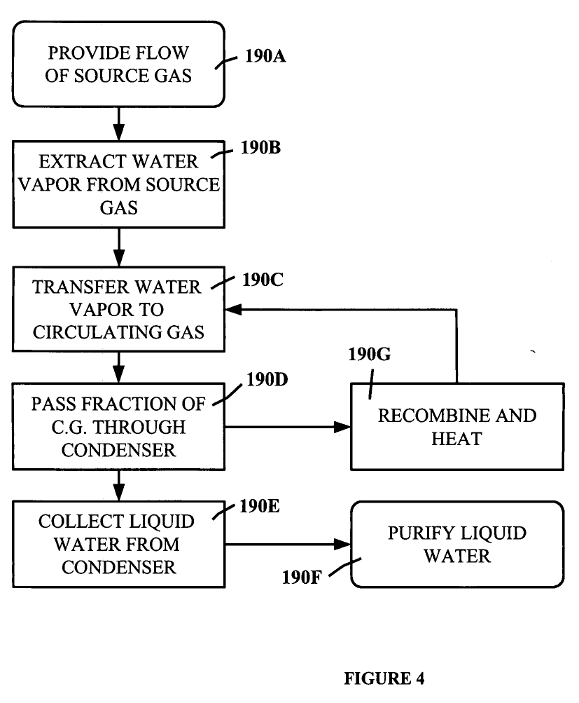

FIG. 4 illustrates a method according to the present invention. Box 190A corresponds to a providing a flow of source gas containing water vapor (such as ambient air). For example, the source gas may enter an open flow path through an intake. Box 190B corresponds to extracting water vapor (moisture) from the source gas, for example by passing the water vapor in the source gas over a sorption wheel. Box 190C corresponds to transferring the absorbed water vapor (moisture) to a circulating gas. For example, rotation of the sorption wheel conveys the moisture to a closed loop air path, and driving air within the closed loop path through the sorption wheel desorbs water vapor from the sorption wheel into the second closed loop air path. Box 190D corresponds to splitting the closed loop air stream, so that a first fraction of the circulating gas passes through a condenser each cycle, while the remainder (or second fraction) passes through a condenser bypass. Box 190E corresponds to collecting condensed liquid water removed from the circulating gas using the condenser, possibly after an optional precooling stage. Box 190F corresponds to purifying the condensed liquid water using a water sterilizing device such as a bacteria killing device. Box 190G corresponds to recombining the first and second fractions of the circulating gas, and heating the recombined circulating gas flow using a heat source, before driving it through the sorption wheel again, for-example using a fan, returning the process to box 190C. The ambient air flow, rotation of sorption wheel, and circulation of gas within the closed paths can all be continuous.

### ALTERNATIVES OF A FIRST EMBODIMENT (FIGS. 4-9)

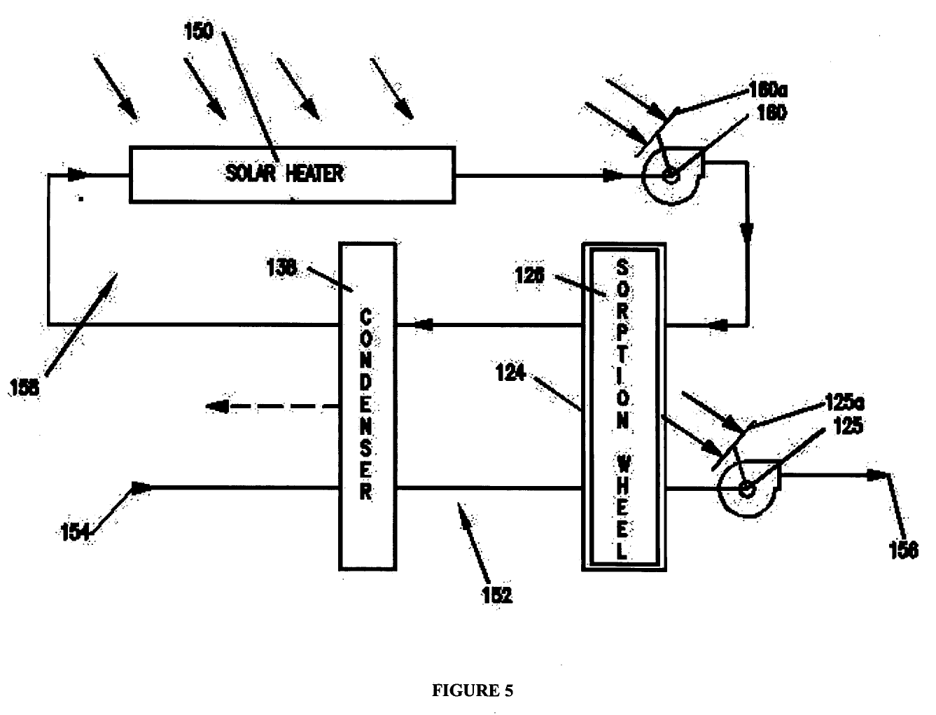

Referring now to FIG. 5, there is a schematic illustration of an alternative configuration of a first embodiment depicted by FIGS. 1 and 2. The first air path 114 and fourth air path 118 of the apparatus shown in FIG. 2 have, in this example, been combined into a common open-air first path 152, thus reducing the number of fans needed in the system by one. First path 152 draws air through outside air intake 154 creating a flow of first path air by means of suction provided by a fan 125, powered by solar voltaic 125a, which further forces system input air 152 through a condensing heat exchanger 138 and a sorption wheel housing 124 containing sorption material 126. Very dry and warmed air after sorption material 126 is pulled by the fan 125, which exhausts this air through outlet 156 with a lower absolute humidity level than intake 154. The second closed-loop air path 116 and third closed-loop air path 117 of the apparatus shown in FIG. 2 have been combined in this example into a single, second path 158, thus eliminating condenser bypass 134 and heat exchanger 136 from the apparatus shown in FIG. 2. The second path, closed-loop air path 158, comprises a portion of sorption wheel housing 124, sorption material 126, condensing heat exchanger 138, solar air heating source 150, and fan 160 powered by solar voltaic 160a. Sorption material 126 can comprise a hygroscopic matrix coated with lithium chloride desiccant to provide very high absorptive and/or adsorptive properties and thus enable extremely low reactivation temperatures to be achieved. Thus, a completely autonomous water generating apparatus is realized using the first (open) path 152 and the second (closed-loop) path 158.

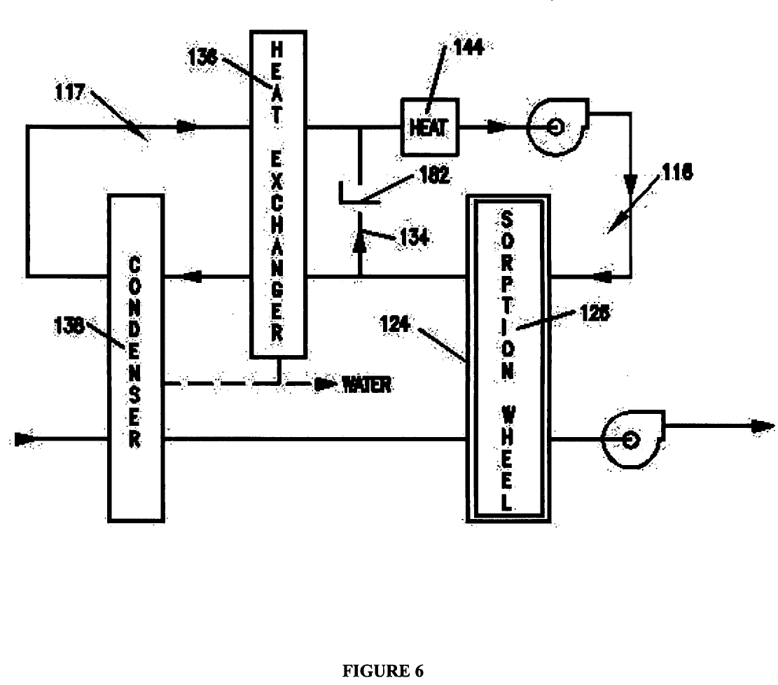

Referring now to FIG. 6, there is a schematic illustration of an alternative configuration of a first embodiment depicted by FIGS. 1 and 2. Modulating damper 182 is positioned on condenser bypass 134, thus allowing for differentiable flow control between the second closed-loop path 116 and the third closed-loop path 117. Increased flow through condenser bypass 134 for extremely arid climates allows for greater energy efficiency. Increased flow through the third closed-loop path 117 for more humid climates allows for greater potable water generation.

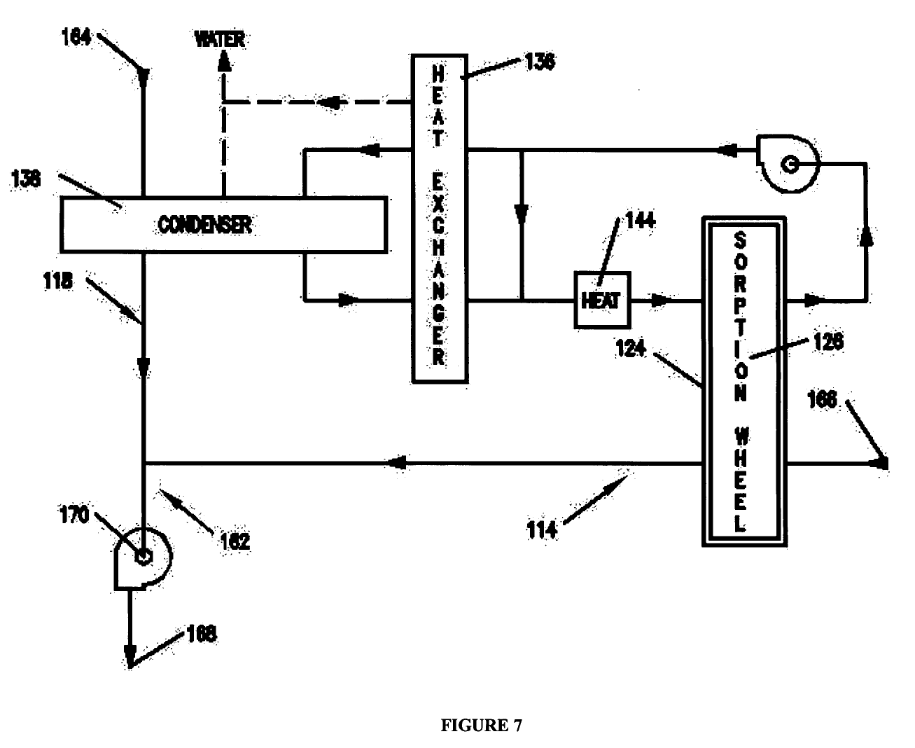

Referring now to FIG. 7, there is a schematic illustration of an alternative configuration of a first embodiment depicted by FIGS. 1 and 2. First air path 114 and fourth air path 118 have been joined to have a common exhaust point 168, thus reducing the number of fans needed in the system by one. Air paths 114 and 118 are drawn through outside air intake 164 and 166 and are then mixed into air path 162 creating a flow of first path air by means of suction provided by a fan 170 which further forces input air through a condensing heat exchanger 138 and sorption wheel housing 124 containing sorption material 126. Thus, the benefit of having a reduced number of fans without increasing the temperature through the sorption wheel and decreasing system performance.

In other embodiments, a closed-loop path may contain two or more sorption wheels series with a correlated (such as equal) number of heating devices. A first path contains a portion of the two or more sorption wheels. Such configurations allow for increased absorption of moisture from the ambient air. The ambient air may also be recirculated over a sorption wheel.

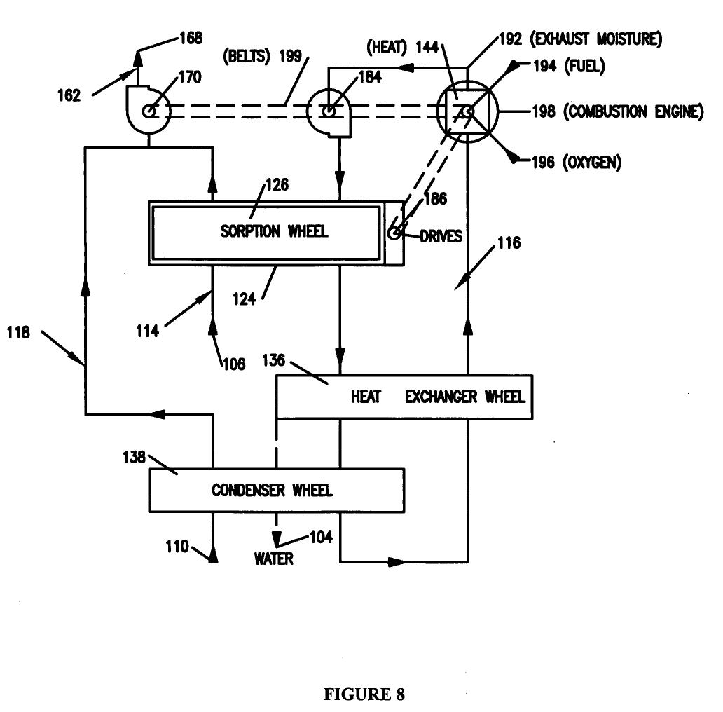

Referring now to FIG. 8, there is a schematic illustration of an alternative configuration of a first embodiment depicted by FIGS. 1 and 2 utilizing cogeneration for combined heat and power. First air path 114 and fourth air path 118 have been joined to have a common exhaust point 168, thus reducing the number of fans needed in the system by one. Air paths 114 and 118 are drawn through outside air intake 164 and 166 and are then mixed into air path 162 creating a flow of first path air by means of suction provided by a fan 170 which further forces input air through a condensing heat exchanger 138 and sorption wheel housing 124 containing sorption material 126. Combustion engine 198 provides motive power to fans 170 and 184, motive power to turn sorption wheel 126, and regeneration heat 144. Fuel 194 and oxygen 196 combine within combustion engine 198 to provide motive power and heat while exhaust 192 carrying moisture is released into closed loop 116. Exhaust 192 can be placed before or after sorption wheel 126. A release before sorption wheel 126 giving the benefit of greater thermal efficiency while a release after sorption wheel 126 giving a greater absorption/adsorption rate. Thus, the overall benefit of autonomous operation without electricity and increased water output through the formation of water vapor as a result of the combustion process. Fan 170, fan 184, and sorption wheel drive 186 are indirectly connected to combustion engine 198 via belts 199. Proper rotational speeds may be achieved through various pulley sizes and gearing. Heat exchanger 136 and condenser 138 are horizontally mounted to allow for condensed water 104 to drain via gravity.

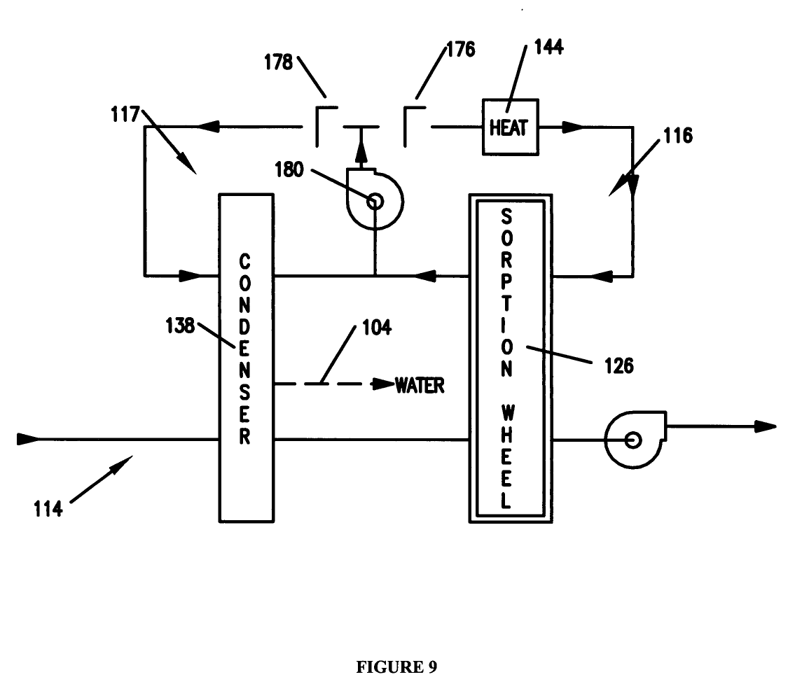

Referring now to FIG. 9, there is a schematic illustration of an alternative configuration of a first embodiment depicted by FIGS. 1 and 2. Modulating dampers 176 and 178 are respectively positioned within a second closed loop path 116 and a third closed loop path 117. Thus, allowing a flow path change whereby circulating fan 180 is located on a common path. During a regeneration phase, damper 178 is closed and damper 176 is open thereby forcing all airflow through closed-loop path 116. Second closed-loop path 116 now contains very humid and hot air. After a duration or predetermined period of time, damper 176 is closed and damper 178 open thereby changing the flow path to that of third closed-loop path 117. In this way, liquid condensate is condensed from closed-cycle path 117 and drained via tube 104. The timing between flow path changes can be adjusted depending on the absolute humidity levels being drawn through open path 114, so that increased efficiency and a greater quantity of water generation results in certain climatic conditions.

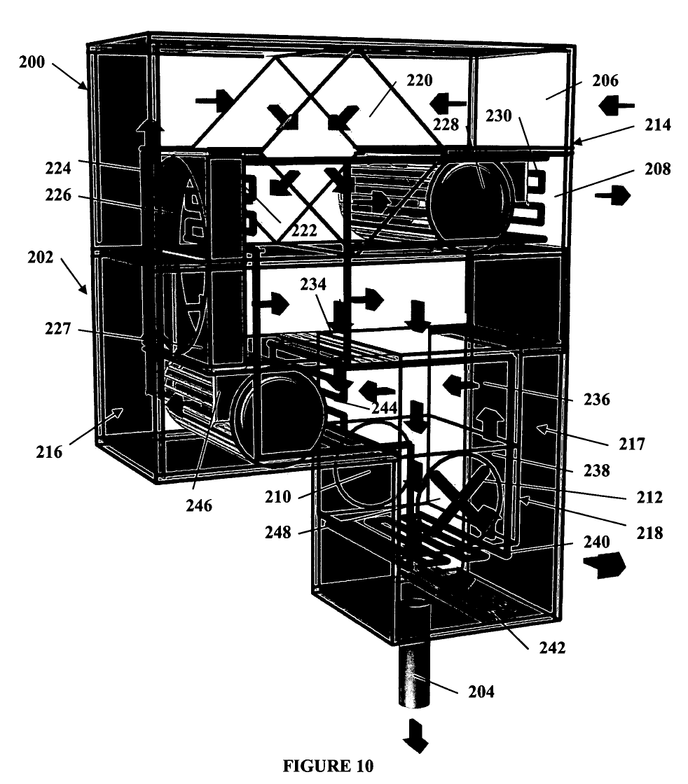

### DESCRIPTION OF A SECOND EMBODIMENT (FIGS. 10-19)

FIG. 10 illustrates an apparatus 200 that produces potable water from air in accordance with a second embodiment of the subject invention, delivering water even with an extremely arid and hot atmosphere. Apparatus 200 comprises water source assembly 202 and water delivery 204. Water source assembly 202 further comprises ambient air intake 206, dry ambient air exhaust 208, condenser air intake 210, and condenser air exhaust 212. Water source assembly 202 further houses four separate air paths: (1) a first path 214, an open path for a source of water vapor, (2) a second path 216, a closed-loop regenerative air path, (3) a third path 217, a closed-loop condensing air path, and (4) a fourth path 218, an open ambient air path. The first path 214 further comprises pre-cool air-to-air heat exchanger 220, pre-cooling evaporator coil 222, portion of wheel housing 224 containing sorption material 226, sorption material motor 227, fan 228, and post cooling or heating coil 230. The second closed-loop air path 216 further comprises portion of wheel housing 224 containing sorption material 226, condenser bypass 234, heat source 244, and fan 246. The third closed-loop air path 217 further comprises condenser bypass 234, pre-condenser heat exchanger 236, condenser heat exchanger 238, condensing evaporator coil 240, and bacteria killing device 242. The fourth air path 218 further comprises portion of condenser heat exchanger 238 and fan 248.

### OPERATION OF A SECOND EMBODIMENT

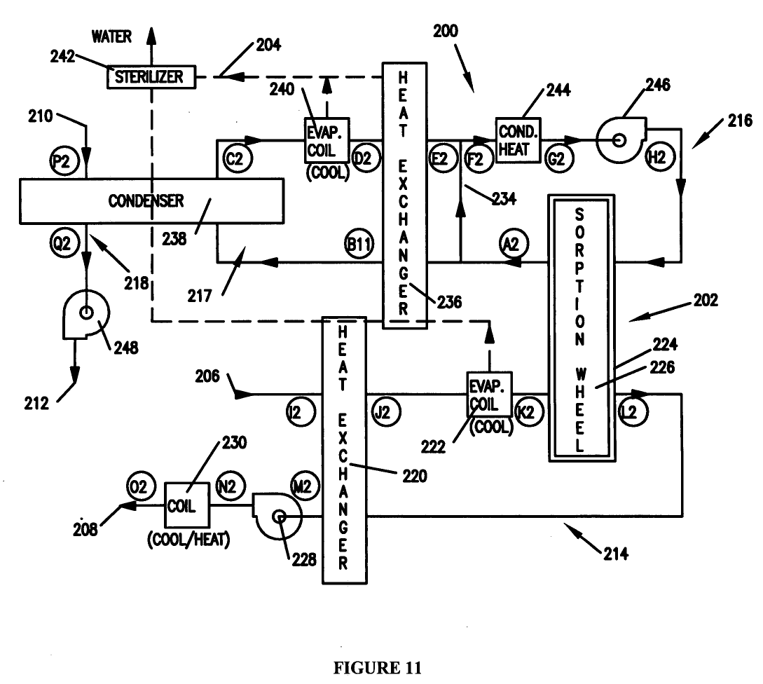

With reference now to FIGS. 10-11, the first path 214 is integrated for ambient air or gas intake comprising a source of water vapor for production of potable water, which is drawn through outside air intake 206 creating a flow of first path air by means of suction provided by a fan 228 which further forces system input air through a first pre-cooling device 220 coupled to a reheating device. A multitude of heat exchanger types could be used herein such as, but not limited to, heat pipes, plate-to-plate, and rotary heat exchangers. A second cooling device 222 further cools first path 214 with the possibility of reaching a temperature beneath the dew point whereby water precipitates from a vapor to a liquid stage. Airflow within the first path 214 passes through a sorption wheel housing 224 containing sorption material 226. In this example, the hygroscopic sorption material is shaped in the form of a wheel, which is continuously rotated by a motorized driving mechanism 227. Sorption material 226 can be made of a hygroscopic matrix coated with lithium chloride desiccant to provide very high absorptive and/or adsorptive properties and thus enable extremely low reactivation temperatures to be achieved. Sorption wheel rotation speed can be increased to create the effect of a passive enthalpy device, or total energy recovery wheel. In this way, efficient operation can be maintained even in very humid conditions. Very dry air after sorption material 226 is pulled by fan 228, which passes through portion of heat exchanger 220, and exhausts through outlet 208 with a lower absolute humidity level than intake 206.

The second path, closed loop regeneration path 216, is integrated and includes a regeneration fan 246 that pushes the hot and very humid air or gas through the second path. Hot and humid air is drawn by the pull effect of the fan 246 across the sorption wheel housing 224 and through the sorption material 226. This changes the vapor pressure of the desiccant contained in the sorption material 226, rejecting water vapor originating from the first path into the second closed-loop regenerative path. The second path then is split, with a percentage (or fraction) transferred to the third path 217 while the remaining flow is re-circulated through condenser bypass 234.

Air traveling through the third path is merged together with flow through the condenser bypass, and subsequently heated by heating device 244. The heating device may use heat from solar heated hot water, solar heated air, solar voltaic electric heat, fossil fuels, or low-grade/temperature waste heat. Fan 246 effects the movement of the airflow and also serves to sensibly increase heat further due to the motor and blades being housed within the second closed-loop path. In this way, no energy is lost due to inefficiencies in the motor housing. With this point, the cycle starts again and is continuous and is in a closed loop path.

The third path, closed loop condensing path 217, shares the common condenser bypass 234 with the second path. Air is diverted from the re-circulating second path into the third path, where fan 246 pushes the very humid air or gas within the third closed-loop path and is drawn through a first condensing heat exchanger 236. A multitude of heat exchanger types could be used herein such as, but not limited to, heat pipes, plate-to-plate, and rotary heat exchangers. The air is pre-cooled with the possibility of reaching a temperature beneath the dew point whereby water precipitates from a vapor to a liquid stage. The flow is then pushed through a condenser 238, a heat exchanger that allows the further cooling of the air or gas to a temperature beneath the dew point through the use of an ambient temperature fourth path 218. The third air path is further cooled by a third condensing device 240 which condensates the humidity content. Liquid condensate from three condensing cooling devices (222, 238, and 240) is further purified by bacteria killing device 242, which may comprise ultraviolet light, ozone, and the like. Water is drained in a liquid state out of the closed loop regeneration path 217, and delivered by condensate tube 204. The third path air stream 217 is now drier than second air stream air (or other gas) in second path 216. The second and third paths together form a recirculating flow configuration.

The fourth path, open ambient condensing path 218, is integrated to provide means to condense water through tube 204 without requiring refrigeration or compression techniques. Fourth open air path is drawn through outside air intake 210 creating a flow of fourth path air by means of suction provided by a fan 248. Sensibly warmed air after passing through portion of condensing heat exchanger 238 is pulled by fan 248, which exhausts this air through outlet 212. Fan 248 only operates when the ambient fourth air path temperature is lower than is capable of being produced by cooling device 240.

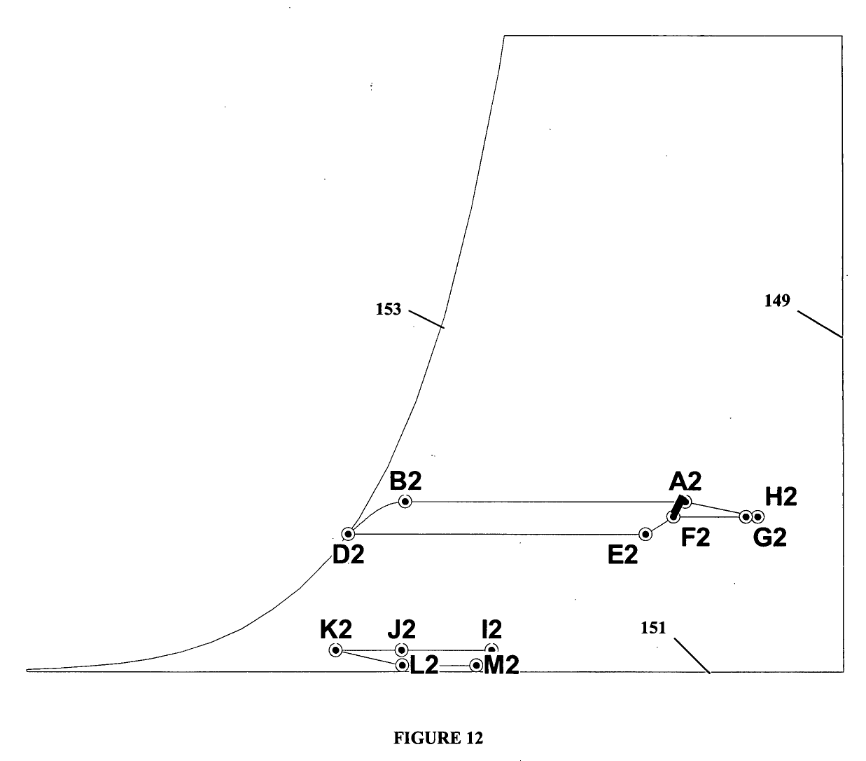

With reference to FIG. 12, there is shown a simplified psychrometric chart illustrating the thermal process illustrated by FIGS. 10 and 11. In FIG. 12, the vertical axis 149 represents the absolute humidity content of water, weight of moisture per weight of dry air. The horizontal axis 151 represents the sensible temperature, measured in temperature units. The curve line 153 presents the saturation of air or gas, which means 100 percent relative humidity. Referring now to the first open path 214, point 12 corresponds to an extremely arid and very hot desert-like ambient climate where the source of water vapor to produce potable water originates. This ambient air 12 is sensibly pre-cooled to J2 and further cooled to K2 with the possibility of reaching a temperature beneath the dew point whereby additional water precipitates from vapor to liquid state. The first airflow path is then pulled through the sorption material and the change of vapor pressure causes sorption material to absorb and/or adsorb almost all the water vapor from the ambient air producing point L2. The first airflow is then heated to point M2.

Referring now to a closed loop regeneration second path 216, hot and relatively dry air H2 is pulled through sorption material and the change of vapor pressure rejects most of the water vapor to the second air path. A percentage of the second air path is re-circulated and mixed with cooler and drier air at F1. Re-circulation of the second path realizes higher dew point temperatures, allowing for water generation in extremely arid climates, and increasing energy efficiency by decreasing condenser energy losses. Now air or gas is sensibly heated to G2 and re-heated by motor and movement of fan 246 to H2, which starts the cycle of the second path again.

Referring now to closed loop regeneration third path 217, warm and very humid air A2 is sensibly cooled to point B2 with the possibility of reaching a temperature beneath the dew point whereby water precipitates from vapor to liquid stage. From B2, air within the third path is further cooled to a temperature beneath the dew point whereby additional water precipitates from vapor to liquid stage at point D2, assuming mechanical means of cooling produces lower temperatures then possible with outside ambient air. Liquid water is further treated and delivered for human consumption or cooling. Now air or gas is cool and with a lower absolute humidity level content than at A2 whereafter the mass of drier air is reheated to E2 and then mixed with closed loop the second air path forming point F2.

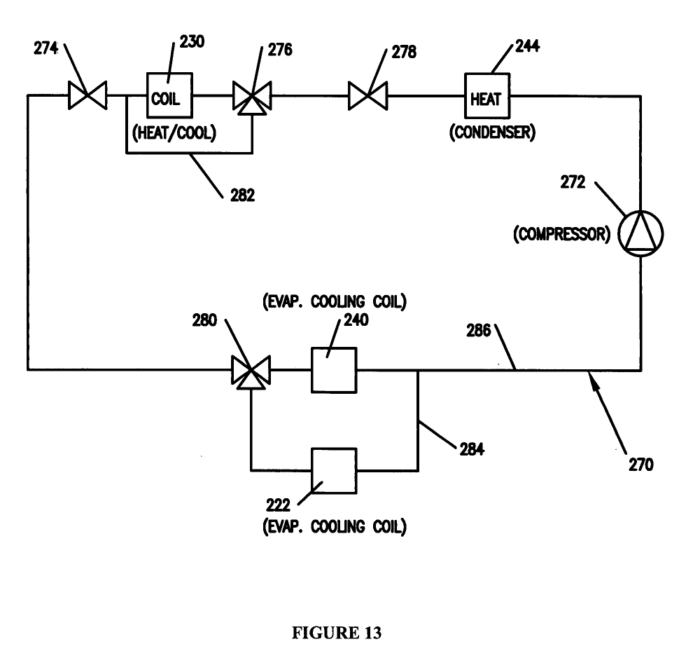

With reference to FIG. 13, there is shown a schematic illustration of a split system refrigeration system cycle 270, providing both heating and cooling to water generating apparatus 200. Condensing heating device 244 transforms refrigerant (which may be an engine coolant) 286 from a vapor state into a liquid state. A first throttling device 278 lowers pressure while maintaining a constant enthalpy. Three-way valve 276 modulates flow through heating or cooling device 230 utilizing bypass 282 when conditions warrant. A second throttling device 274 further lowers pressure while maintaining a constant enthalpy. Three-way valve 280 splits refrigerant 286 between closed-loop path 270 and branch path 284. Evaporative cooling coils 240 and 222 are arranged in parallel. Evaporative cooling coils 240 and 222 increases enthalpy with a constant pressure, changing refrigerant 286 back to a vapor state. Refrigerant flow through closed-cycle path 270 then undergoes an increase in pressure by compressor 272. With this point, the cycle starts again and is continuous and is in a closed loop path.

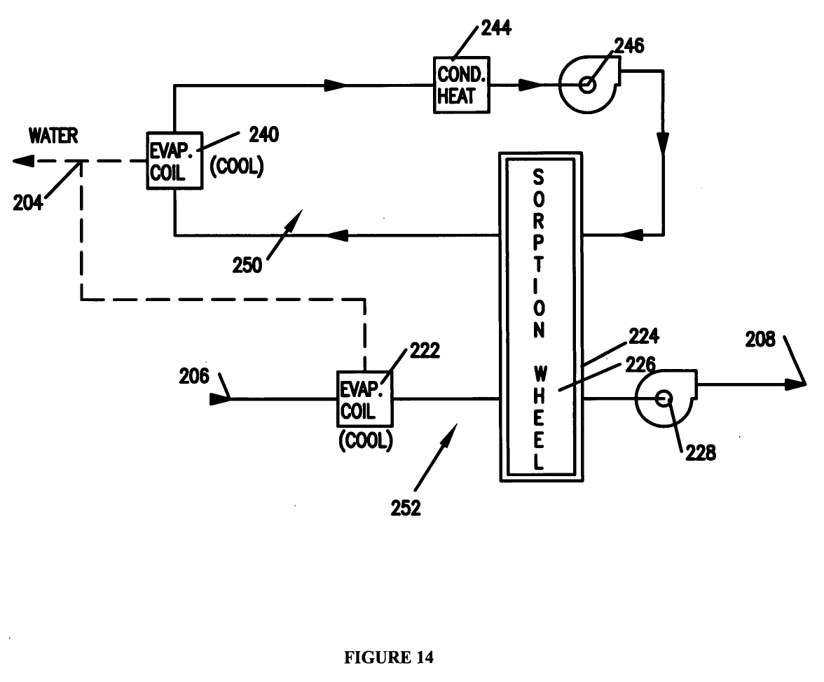

### ALTERNATIVES OF A SECOND EMBODIMENT (FIGS. 14-16)

Referring now to FIG. 14, there is a schematic illustration of an alternative configuration of a first embodiment depicted by FIGS. 10 and 11. Fourth path 218 of the example shown in FIG. 11 has been completely eliminated, thus reducing the number of fans needed in the system by one. First path 252 draws in outside air through intake 206, creating a flow of first path air by means of suction provided by a fan 228. The fan 228 further forces air drawn through intake 206 through a split system refrigeration evaporator coil 222 with the possibility of reaching a temperature beneath the dew point whereby water precipitates from a vapor to a liquid stage, the water exiting the first air path 252 via tube 204.

Air within the first path 252 is further pulled through a sorption wheel housing 224 containing sorption material 226. Very dry and warmed air after sorption material 226 is pulled by fan 228, which exhausts this air through outlet 208 with a lower absolute humidity level than intake 206. The second closed-loop air path 216 and third closed-loop air path 217 of the apparatus shown in FIG. 11 have been combined in this example into a single, second path 250, thus eliminating condenser bypass 234 and heat exchanger 236. The second path, closed-loop air path 250, comprises portion of sorption wheel housing 224, sorption material 226, split system refrigeration condensing evaporator coil 240, split system refrigeration condensing heating coil 244, and fan 246.

Split system refrigeration cycle evaporator coils 240 and 222 are coupled to condenser coil 244 for an efficient distribution of heat. Sorption material 226 can be made of a hygroscopic matrix coated with lithium chloride desiccant to provide very high absorptive and/or adsorptive properties and thus enable extremely low reactivation temperatures to be achieved. Due to the extremely low reactivation temperatures achievable with the lithium chloride desiccant sorption material 226, traditional refrigerants can be used in the refrigeration cycle without modification. Thus, a water generating apparatus is realized using the first (open) path 252 and the second (closed-loop) path 250.

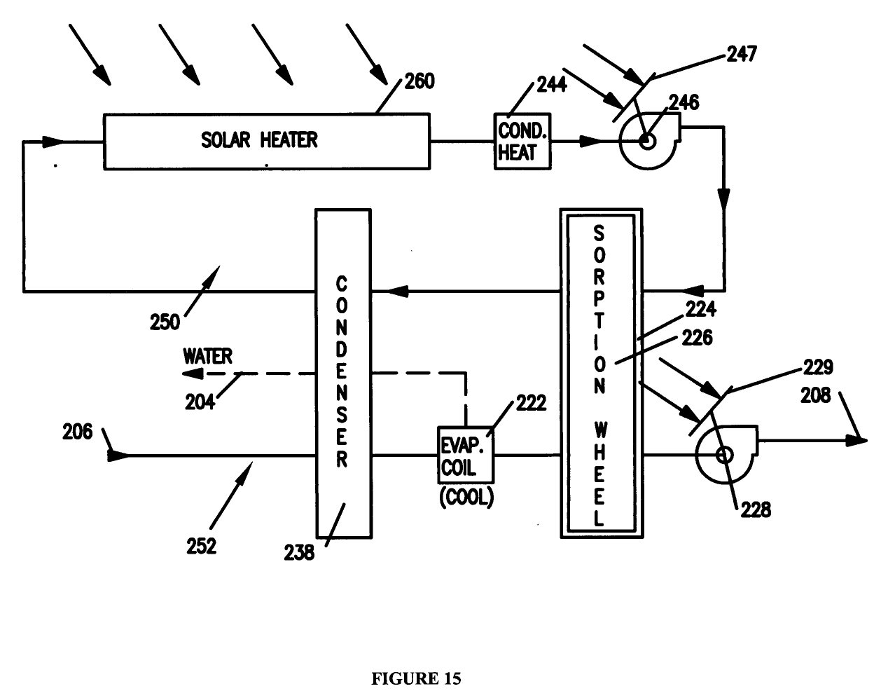

Referring now to FIG. 15, there is a schematic illustration of an alternative configuration of a second embodiment depicted by FIGS. 10 and 11. Fourth air path 218, as shown in the apparatus of FIG. 11, has been completely eliminated, thus reducing the number of fans needed in the system by one. First path 252 draws air through outside air intake 206, creating a flow of first path air by means of suction provided by a fan 228. The fan 228 further forces air drawn through intake 206 through condensing heat exchanger 238 and a split system refrigeration evaporator coil 222 with the possibility of reaching a temperature beneath the dew point whereby water precipitates from a vapor to a liquid stage and exits the first air path 252 via tube 204. Photovoltaic panels 229 and 247 and power fans 228 and 246, respectively.

Air within first path 252 is further pulled through a sorption wheel housing 224 containing sorption materials 226. Very dry and warmed air after sorption material 226 is pulled by fan 228, which exhausts this air through outlet 208 with a lower absolute humidity level than intake 206. The second closed-loop air path 216 and third closed-loop air path 217 of the apparatus shown in FIG. 11 have been combined into a single second path 250, thus eliminating condenser bypass 234. The second path, closed-loop air path 250 comprises a portion of sorption wheel housing 224, sorption material 226, condensing heat exchanger 238, solar pre-heating device 260, split system refrigeration condensing heating coil 244, and fan 246.

Split system refrigeration cycle evaporator coil 222 is coupled to condenser coil 244 for an efficient distribution of heat. Sorption material 226 can be made of a hygroscopic matrix coated with lithium chloride desiccant to provide very high absorptive and/or adsorptive properties and thus enable extremely low reactivation temperatures to be achieved. Due to the extremely low reactivation temperatures achievable with the lithium chloride desiccant sorption material 226, traditional refrigerants can be used in the refrigeration cycle without modification. Thus, a water generating apparatus is realized using the first (open) path 252 and the second (closed-loop) path 250.

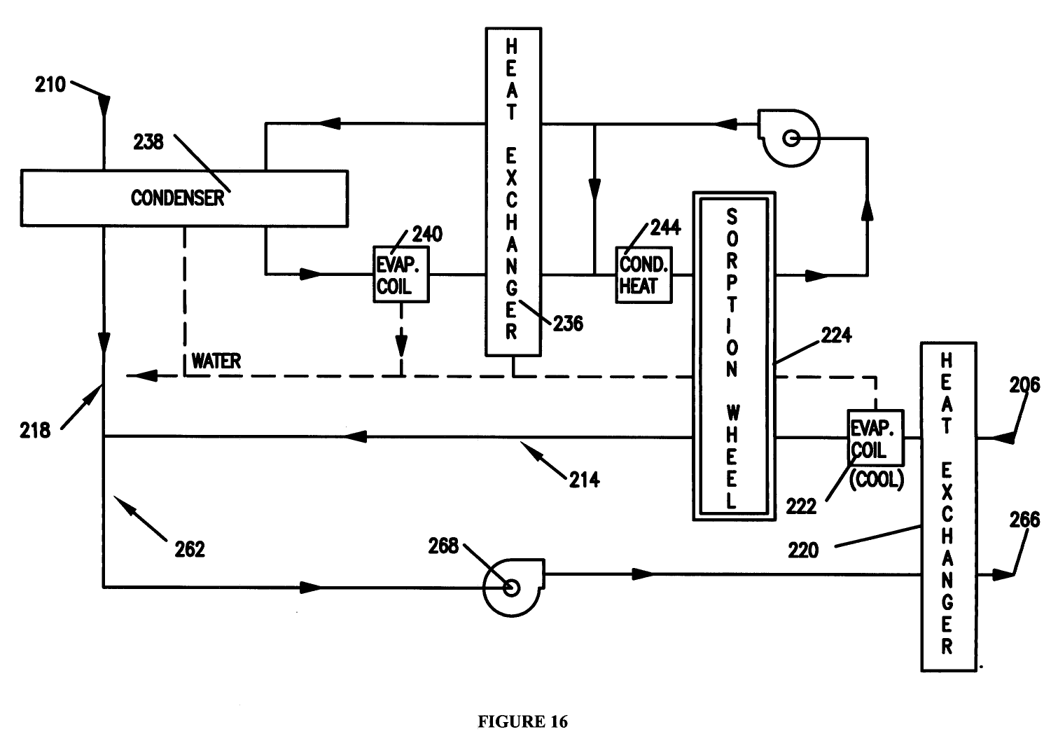

Referring now to FIG. 16, there is a schematic illustration of an alternative configuration of a second embodiment depicted by FIGS. 10 and 11. First air path 214 and fourth air path 218 have been joined to have a common exhaust point 266, thus reducing the number of fans needed in the system by one. Air within paths 214 and 218 are drawn through outside air intakes 206 and 210 respectively, and are then mixed into air path 262 creating a flow of first path air by means of suction provided by a fan 268 which further forces input air through a condensing heat exchanger 238, sorption wheel housing 224 and heat exchanger 220. This provides the benefit of having a reduced number of fans without increasing the temperature through the sorption wheel.

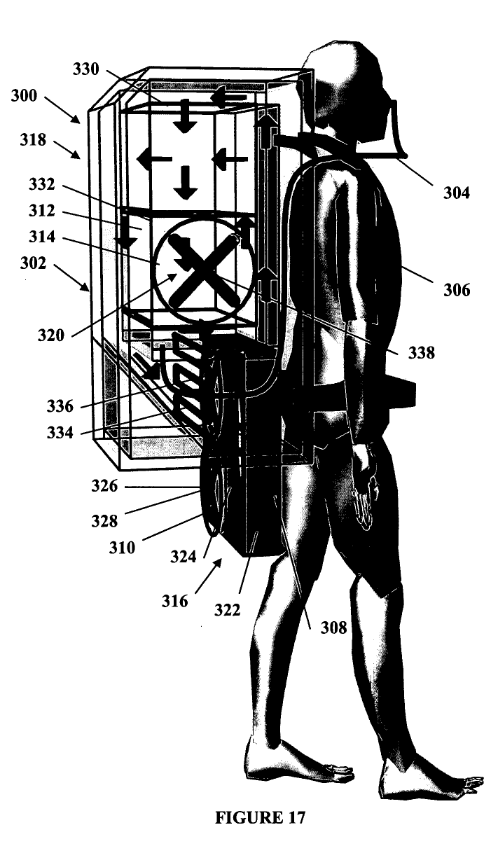

### DESCRIPTION OF A THIRD EMBODIMENT (FIGS. 17-19)

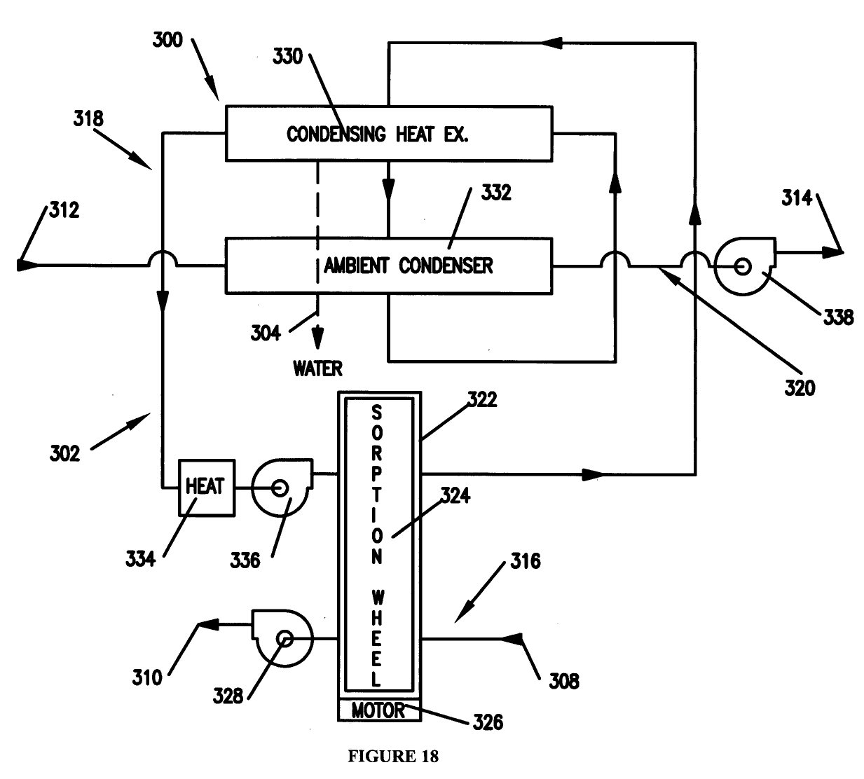

FIGS. 17 and 18 illustrate a portable method and apparatus that produces potable water from air 300 in accordance with a third embodiment of the subject invention, delivering water even with an extremely arid atmosphere. Apparatus 300 comprises water source assembly 302, water delivery tube 304, and harness 306. Water source assembly 302 further comprises ambient air intake 308, dry ambient air exhaust 310, condenser air intake 312, and condenser air exhaust 314. Water source assembly 302 further houses three separate air paths: (1) a first path 316, an open ambient air path for a source of water vapor; (2) a second path 318, a closed-loop regenerative air path; and (3) a third path 320, a condenser ambient air path. The first path, water vapor source ambient air path 316, comprises a portion of wheel housing 322 containing sorption material 324 (driven by sorption material motor 326), and fan 328. The second path, regenerative closed-loop air path 318, comprises portion of wheel housing 322 containing sorption material 324, pre-condenser heat exchanger 330, condenser heat exchanger 332, heating source 334, and fan 336. The third path, condenser ambient air path 320, comprises a portion of condenser heat exchanger 332 and fan 338.

### OPERATION OF A THIRD EMBODIMENT

With reference now to FIGS. 17 and 18, the first path 316 is integrated for ambient air or gas intake comprising a source of water vapor for production of potable water, which is drawn through outside air intake 308 creating a flow of first path air by means of suction provided by a fan 328 which further forces system input air 316 through a sorption wheel housing 322 containing sorption material 324. This hygroscopic sorption material can be shaped in the form of a wheel 324, which is continuously rotated by a motorized driving mechanism 326. Alternatively, the sorption wheel 324 may be rotated without a motor by a weight differential between a dry half and a saturated half. The wheel may be mounted on an angle to generate this effect. The wheel may also be manually rotated.

Sorption material 324 can be made of a hygroscopic matrix coated with lithium chloride desiccant to provide very high absorptive and/or adsorptive properties and thus enable extremely low reactivation temperatures to be achieved. Very dry and warmed air after sorption material 324 is pulled by fan 328, which exhausts this air through outlet 310 with a lower absolute humidity level than intake 308. Fan 328 can be a compact, light, and efficient propeller, or the like.

The second path or closed loop regeneration path 302 is integrated and includes a regeneration fan 336 that pushes the hot and very humid air or gas through closed-loop path 302. Hot and humid air is drawn by the pull effect of the fan 336 across the sorption wheel housing 322 and through a portion of sorption material 324. This changes the vapor pressure of the desiccant contained in the sorption material 324 rejecting water vapor originating from the first path into the second regenerative path. Air path 302 is further drawn through a first condensing heat exchanger 330. The heat exchanger can comprise heat pipes, plate-to-plate, rotary heat exchangers, or other heat-exchanger type. Preferably, the heat exchanger comprises a lightweight material such as aluminum, paper, or plastic, thereby reducing weight.

The air is pre-cooled with the possibility of reaching a temperature beneath the dew point whereby water precipitates from a vapor to a liquid stage. The flow is then pushed through an ambient condenser 332, a heat exchanger that allows the further cooling of the air or gas to a temperature beneath the dew point through the use of an ambient temperature third path 320. The pre-cooled air or gas 302 when crossing the condensing heat exchanger 332 condensates the humidity content in the form of water. Water is drained in a liquid state out of closed loop regeneration path 302 delivered by condensate tube 304. Condensate tube may terminate in the mouth of a human carrier or can be fed into a water storage container.

Flow within the condensate tube can be induced by suction created by a human carrier from their mouth, gravity, or via an installed pump. Preferably condensing heat exchanger 330 is located directly above condensing heat exchanger 304, which is located directly above condensate tube 304 for gravitational collection of potable water. Heating device 334 may comprise one or more temperature changing sources, such as solar heated hot water, solar heated air, solar voltaic electric heat, fossil fuels, or low-grade/temperature waste heat. Fan 336 effects the movement of the airflow and also serves to sensibly increase heat further due to the motor and blades being housed within second closed-loop path. In this way, no energy is lost due to inefficiencies in the motor housing. With this point, the cycle starts again and is continuous and is in a closed loop path.

The third path, open ambient condensing path 320, is integrated to provide means to condense water through tube 304 without requiring refrigeration or compression techniques. Third open air path is drawn through outside air intake 312 creating a flow of third path air by means of suction provided by a fan 338. Fan 338 can be of a compact, light, and efficient propeller or like there of. Sensibly warmed air after passing through portion of condensing heat exchanger 332 is pulled by fan 338, which exhausts this air through outlet 314.

FIG. 17 shows harness 306 is attached to water generating assembly 302, and provides a means for a human to carry the apparatus on their back. Although this is the means, the method of carrying can be varied. Harness 306 can be fabricated using material and techniques commonly known by those skilled in the art of backpack fabrication. Water generating assembly 302 can be fabricated with one or more materials such as insulating fabric, plastic, paper, rubber, leather, aluminum, steel, or the like. The materials can be chosen so as to be insulating, lightweight, flexible, weather resistant, and durable. For example, fabric materials commonly used in the construction of high performance coats can be used, with the pressure generated by fan 336 expanding the material and creating an air passage.

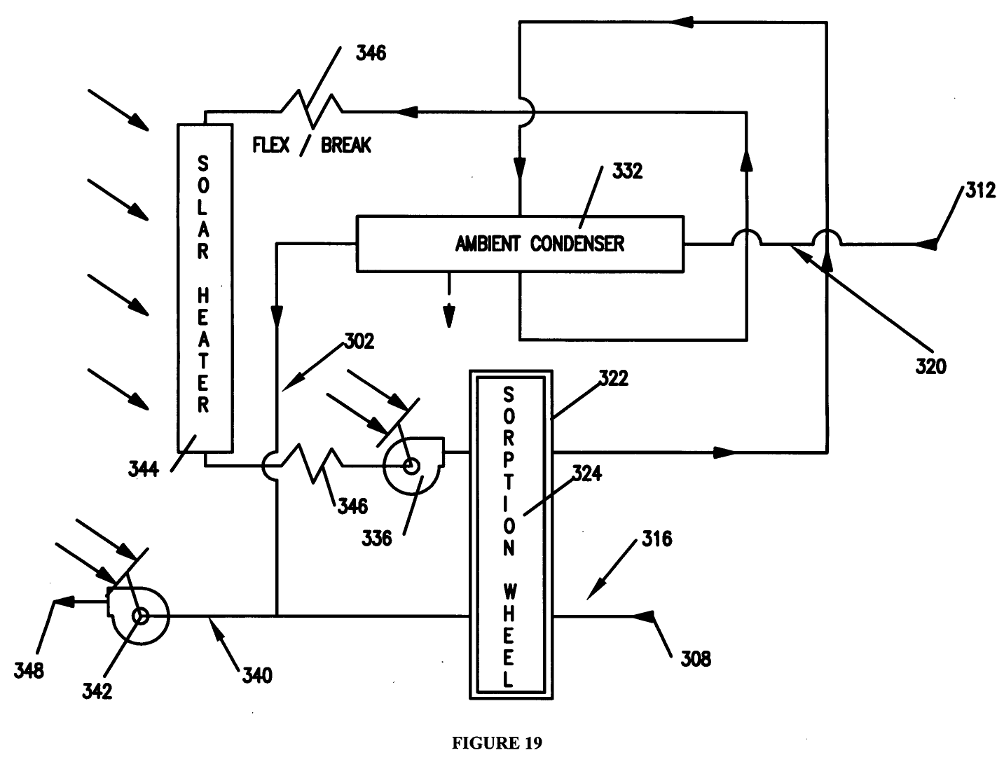

### ALTERNATIVES OF A THIRD EMBODIMENT (FIG. 19)

Referring now to FIG. 19, there is a schematic illustration of an alternative configuration of a third embodiment depicted by FIGS. 17 and 18. First air path 316 and third air path 320 have been joined to have a common exhaust point 348, thus reducing the number of fans needed in the system by one. Air paths 316 and 320 are drawn through outside air intake 308 and 312 and are then mixed into air path 340 creating a flow of first path air by means of suction provided by a fan 342 which further forces input air through a condensing heat exchanger 332 and sorption wheel housing 322 containing sorption material 324. Thus, the benefit of having a reduced number of fans without increasing the temperature through the sorption wheel and decreasing system performance. Heating device 344 is depicted as a solar air heater or solar hot water system. Heating device 344 may be permanently constructed into assembly 302 or it can be detached via flexible connections 346. Heating air device 344 may be unrolled or unpacked when not in transit. It may be constructed of flexible clear plastic with a dark colored backing so that air that passes through is subsequently heated. Fans 342 and 336 are realized for capability to be powered off of solar voltaic. Fans 342 and 336 can also be powered through a combined heat and power setup such as illustrated in FIG. 8. An autonomous, portable water-generating device from source air is realized.

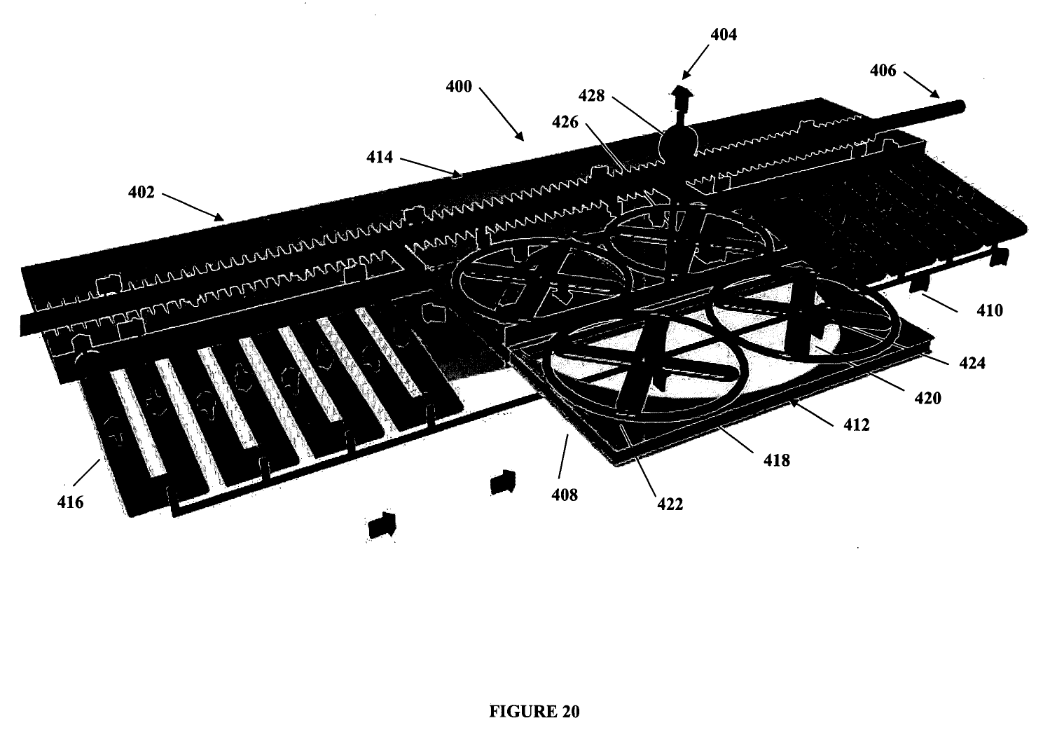

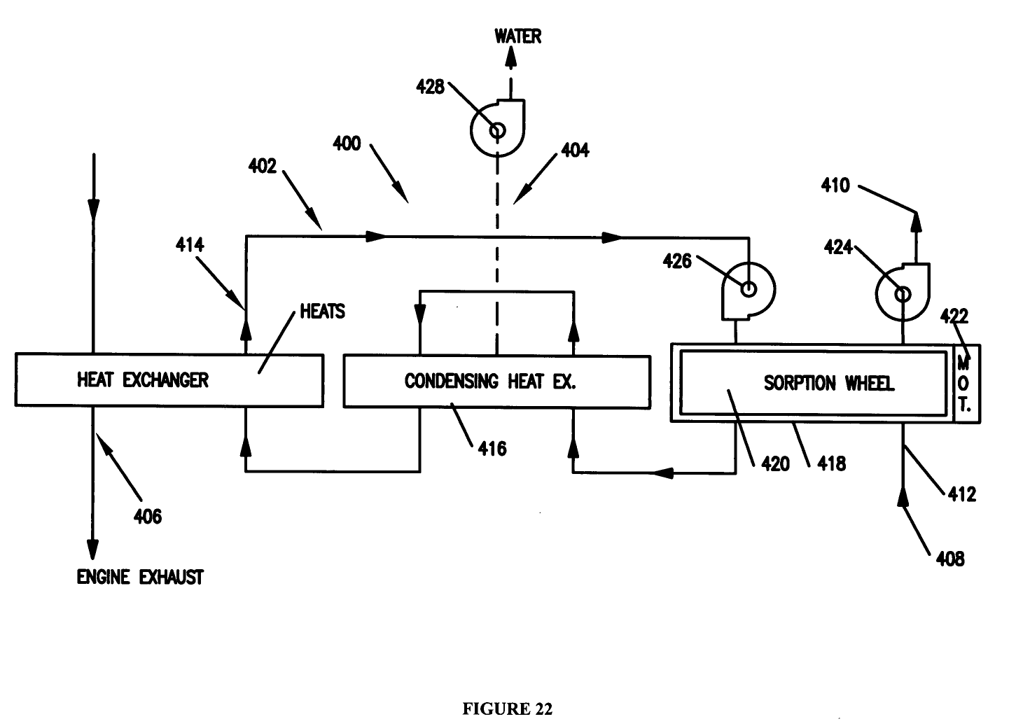

### DESCRIPTION OF A FOURTH EMBODIMENT (FIGS. 20-22)

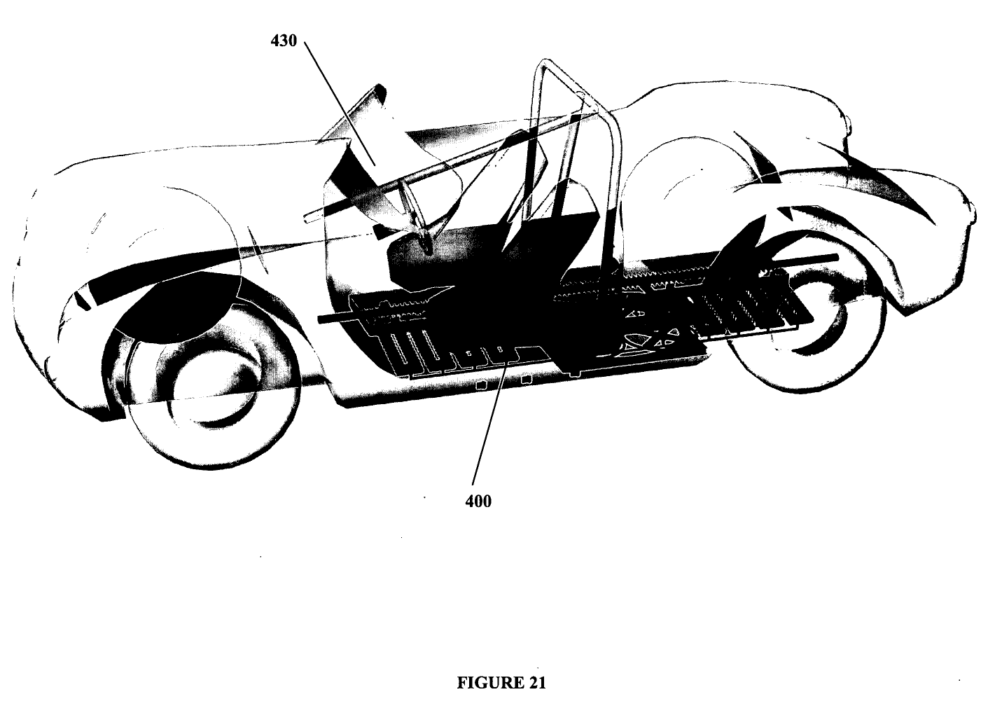

FIGS. 20 and 21 illustrate a method and apparatus 400 that produces potable water from air in accordance with a fourth embodiment of the subject invention, using waste exhaust heat from the engine of a mobile vehicle 430. Apparatus 400 comprises water source assembly 402, water delivery tube 404, and exhaust pipe 406. Water source assembly 402 comprises ambient air intake 408, and dry ambient air exhaust 410. Water source assembly 402 houses three separate air paths: (1) a first path, water vapor source ambient air path 412; (2) a second path, closed-loop regenerative air path 414; and (3) a third path, condenser open air path 416. The first path 412, water vapor source ambient air path 412, comprises a portion of wheel housing 418 containing sorption material 420 (driven by sorption material motor 422), and fan 424. The second path, closed-loop regenerative air path 414, comprises a portion of wheel housing 418 containing sorption material 420, condenser heat exchanger 422, and fan 426. Water source assembly 402 contains condensate pump 428. The third path, condenser open-air path 416, dissipates heat via air movement generated by the movement of the mobile vehicle 430.

### OPERATION OF A FOURTH EMBODIMENT

With reference now to FIGS. 20-22, the first path 412 is integrated for ambient air or gas intake comprising a source of water vapor for production of potable water, which is drawn through the underside of the mobile vehicle 430 through a horizontally mounted outside air intake 408 creating a flow of first path air by means of suction provided by a propeller fan 424 which further forces system input air 412 through a horizontally mounted sorption wheel housing 418 containing sorption material 420. This hygroscopic sorption material can be shaped in the form of a wheel 420, which is continuously rotated by a motorized driving mechanism 422. Alternatively, the sorption wheel 420 may be rotated without a motor by a weight differential between a dry half and a saturated half. The wheel may be mounted on an angle to generate this effect. Sorption material 420 can be made of a hygroscopic matrix coated with lithium chloride desiccant to provide very high absorptive and/or adsorptive properties and thus enable extremely low reactivation temperatures to be achieved. Very dry and warmed air after sorption material 420 is pulled by fan 424, which exhausts this air through outlet 410 with a lower absolute humidity level than intake 408. Fan 424 can be a compact, light, and efficient propeller, or the like. Open flow path 412 intake 408 can be created with air scoops to allow air to be drawn up from beneath a mobile vehicle simply by its forward travel, thereby allowing for operation without fan 424.

The second path or closed loop regeneration path 414 is integrated and includes a regeneration fan 426 that pushes the hot and very humid air or gas through the closed-loop path 414. Hot and humid air is drawn by the pull effect of the fan 426 across the horizontally mounted sorption wheel housing 418 and through a portion of sorption material 420. This changes the vapor pressure of the desiccant contained in the sorption material 420, rejecting water vapor originating from the first path into the second regenerative path. Air path 414 is further drawn through a condensing heat exchanger 416. The heat exchanger can comprise heat pipes, plate-to-plate, rotary heat exchangers, or other heat exchanger type. Preferably, the heat exchanger is of a construction that stands up to the corrosive environment found on the underside of the mobile vehicle 430.

The air is cooled to a temperature beneath the dew point by exposure to ambient temperature air whereby water precipitates from a vapor to a liquid stage. Condensing heat exchanger 416 is set to an angle in which water is gravity drained in a liquid state out of closed loop regeneration path 414 and into condensate tube 404. Flow within the condensate tube 404 is induced by suction created by an installed pump 428. Heating device 406 may comprise one or more of a plurality of different temperature changing sources, but engine exhaust gases preferably provide the heating. At this point, the cycle starts again, and is continuous and is in a closed loop path. By this method, generation of potable water from ambient air through the use of waste heat generated by a mobile vehicle is realized.

Water can be used for a variety of uses including, but not limited to, human consumption, agricultural uses, industrial processes, or can be used as an engine coolant system. The apparatus 400 can replace a conventional radiator, by allowing liquid water produced by the apparatus 400 to undergo a liquid-to-vapor phase change within the engine compartment to provide an alternative cooling system.

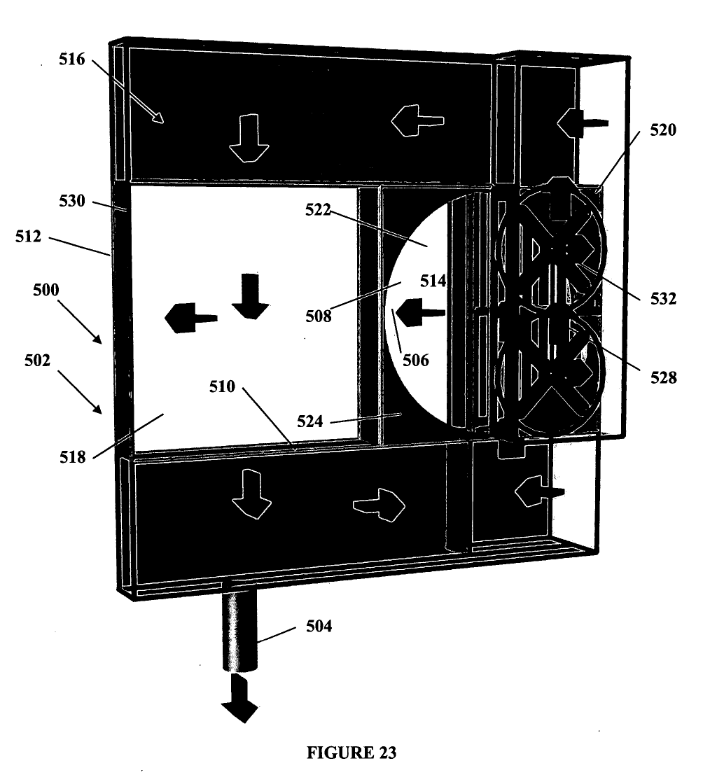

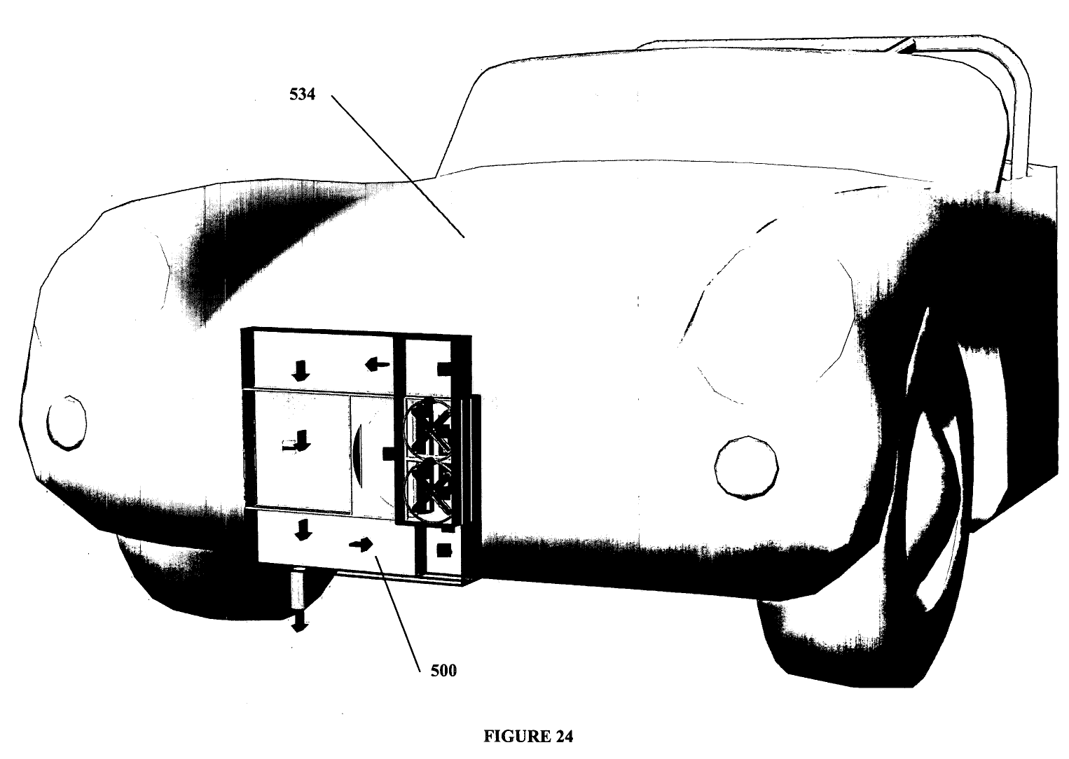

### DESCRIPTION OF A FIFTH EMBODIMENT (FIGS. 23-24)

Referring now to FIG. 23 illustrates a method and apparatus that produces potable water from air 500 in accordance with a fifth embodiment of the subject invention using radiator heat from an engine of a mobile vehicle 534. Apparatus 500 comprises water source assembly 502 and water delivery tube 504. Water source assembly 502 further comprises ambient air vapor intake 506, dry ambient air exhaust 508, condenser air intake 510, and condenser air exhaust 512. Water source assembly 502 further houses three separate air paths: (1) a first open path 514 for a source of water vapor, (2) a second closed-loop regenerative path 516, (3) a third condenser open path 518. The first path 514, providing a source of water vapor from ambient air, comprises a portion of wheel housing 520 containing sorption material 522 (rotated by sorption material motor 524). The second path, regenerative closed-loop path 516, comprises a portion of wheel housing 520 containing sorption material 524, radiator heating element 528, condenser heat exchanger 530, and fan 532. The third path, condensing ambient air path 518, comprises a portion of condensing heat exchanger 530.

### OPERATION OF A FIFTH EMBODIMENT

With reference now to FIGS. 23 and 24, the first path 514 is integrated for ambient air or gas intake comprising a source of water vapor for production of potable water, which is drawn through the front side of a mobile vehicle 534 through a vertically mounted outside air intake 514 creating a flow of first path air by means of suction provided by forward movement of mobile vehicle 534 which further forces system input air 514 through a vertically mounted sorption wheel housing 508 containing sorption material 522. This hygroscopic sorption material can be shaped in the form of a wheel 522, which is continuously rotated by a motorized driving mechanism 524. Alternatively, the sorption wheel 522 may be rotated without a motor by forced convection through the wheel due to forward movement of mobile vehicle 534. A mechanical coupling to the vehicle engine may also rotate the sorption wheel. The wheel may be mounted on an angle to generate this effect, or air scoops provided so as to induce rotation of the sorption wheel. Sorption material 522 can comprise a hygroscopic matrix coated with lithium chloride desiccant to provide very high absorptive and/or adsorptive properties and thus enable extremely low reactivation temperatures to be achieved. Very dry and warmed air after sorption material 522 is pulled by natural suction, which exhausts this air with a lower absolute humidity level.

The second path, closed loop regeneration path 516, is integrated and includes a regeneration fan 532 that pushes the hot and very humid air or gas through the closed-loop path 516. Hot and humid air is drawn by the pull effect of the fan 532 across the vertically mounted sorption wheel housing 520 and through a portion of sorption material 522. This changes the vapor pressure of the desiccant contained in the sorption material 522 rejecting water vapor originating from the first path 514 into the second regenerative path 516. Air path 516 is further drawn through a condensing heat exchanger 530. The heat exchanger can comprise heat pipes, plate-to-plate, rotary heat exchangers, or other heat exchanger design. Preferably, the heat exchanger is of a durable construction that stands up to the corrosive environment found on the front side of the mobile vehicle 534.

The air is cooled to a temperature beneath the dew point by exposure to ambient temperature air whereby water precipitates from a vapor to a liquid stage. Condensing heat exchanger 530 is set to a vertical angle in which water is gravity drained in a liquid state out of closed loop regeneration path 516 and into condensate tube 504. Flow within the condensate tube 504 is induced by gravity. Heating device 528 may comprise one or more of a plurality of different temperature changing sources, but is preferably the engine cooling system radiator for passage of engine coolant from the mobile vehicle 534. With this point, the cycle starts again and is continuous and is in a closed loop path. By this method, generation of potable water from ambient air through the use of engine coolant waste heat generated by a mobile vehicle 534 is realized.

Water can be used for a variety of uses including, but not limited to, human consumption, agricultural uses, industrial processes, or can be used as an engine coolant system, thereby replacing an engine cooling system by allowing liquid water produced by the apparatus 500 to undergo a liquid-to-vapor phase change within the engine compartment, providing an alternative cooling system.

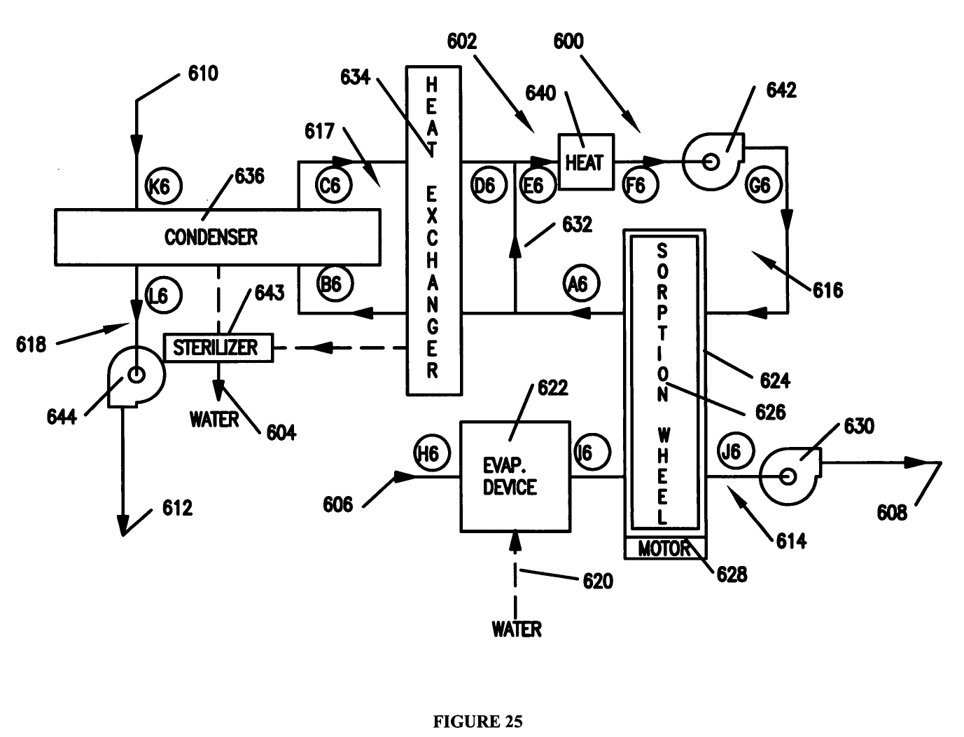

### DESCRIPTION OF A SIXTH EMBODIMENT (FIGS. 25-29)

FIG. 25 illustrates an apparatus 600 that filters water into purified distilled water in accordance with a sixth embodiment of the subject invention. Apparatus 600 comprises water source assembly 602 and water delivery 604. Water source assembly 602 further comprises ambient air intake 606, dry ambient air exhaust 608, condenser air intake 610, and condenser air exhaust 612. Water source assembly 602 further houses four separate air paths: (1) a first path, open path 614 with water to be purified; (2) a second path, closed-loop regenerative air path 616; (3) a third path, closed-loop condensing air path 617; and (4) a fourth path, open ambient air path 618. The first path 614 comprises dirty water intake 620, evaporation device 622, portion of wheel housing 624 containing sorption material 626 (rotated by sorption material motor 628), and fan 630. The second path, closed-loop air path 616, comprises a portion of wheel housing 624 containing sorption material 626, condenser bypass 632, heat source 640, and fan 642. The third path, closed-loop air path 617, comprises condenser bypass 632, pre-condenser heat exchanger 634, condenser heat exchanger 636, and bacteria killing device 643. The fourth path 618 comprises a portion of condenser heat exchanger 636 and fan 644.

### OPERATION OF A SIXTH EMBODIMENT

With reference now to FIG. 25, the first path 614 is integrated for ambient air or gas intake comprising a source of water to be purified, which is drawn through outside air intake 606 creating a flow of first path air by means of suction provided by a fan 630 which further forces system input air 606 through an evaporative device 622. Non-purified water is delivered to evaporative device 622 via tube 620 by gravity or pump. Air within the first path is then pulled through sorption wheel housing 624 containing sorption material 626. This hygroscopic sorption material can be shaped in the form of a wheel 624, which is continuously rotated by a motorized driving mechanism 628. Sorption material 626 can be made of a hygroscopic matrix coated with lithium chloride desiccant to provide very high absorptive and/or adsorptive properties and thus enable extremely low reactivation temperatures to be achieved. Very dry and warmed air after sorption material 626 is pulled by fan 630, which exhausts this air through outlet 608.

The second path, closed loop regeneration path 616, is integrated and includes a regeneration fan 642 that pushes the hot and very humid air or gas through the second path. Hot and humid air is drawn by the pull effect of the fan 642 across the sorption wheel housing 624 and through the sorption material 626. This changes the vapor pressure of the desiccant contained in the sorption material 626 rejecting water vapor originating from the first path into the second path. The second path then diverges with a percentage transferred to a third path, closed-loop path 617, while remaining flow is re-circulated through condenser bypass 632. Air traveling through the third path is merged together with flow from the second path and subsequently heated. Heating device 640 may comprise one or more of a plurality of different temperature changing sources including solar heated hot water, solar heated air, solar voltaic electric heat, fossil fuels, or low-grade/temperature waste heat. Fan 642 effects the movement of the airflow and also serves to sensibly increase heat further due to the motor and blades being housed within the second closed-loop path. In this way, no energy is lost due to inefficiencies in the motor housing. With this point, the cycle starts again and is continuous and is in a closed loop path.

The third path, closed loop condensing path 617, shares a common condenser bypass 632 with the second path. Air is diverted from the re-circulating second path into the third path where fan 642 pushes the very humid air or gas within the third path through a first condensing heat exchanger 634. A heat exchanger can comprise heat pipes, plate-to-plate, rotary, or other types of heat exchangers. The air is pre-cooled with the possibility of reaching a temperature beneath the dew point whereby water precipitates from a vapor to a liquid stage. The flow is then pushed through a condenser 636, a heat exchanger that allows the further cooling of the air or gas to a temperature beneath the dew point through the use of an ambient temperature fourth path 618. The pre-cooled air or gas in path 617, when crossing the condensing heat exchanger 636, condensates the humidity content and this liquid condensate is further purified by bacteria killing device 643 comprising ultraviolet light, ozone, and the like. Water is drained in a liquid state out of closed loop regeneration path 617 delivered by condensate tube 604. The air in the third path 617 is now dryer than second air stream air or gas 618.

The fourth path, open ambient condensing path 618, is integrated to provide means to condense water through tube 604 without requiring refrigeration or compression techniques. The fourth open air path is drawn through outside air intake 610 creating a flow of fourth path air by means of suction provided by a fan 644. Sensibly warmed air after passing through portion of condensing heat exchanger 636 is pulled by fan 644, which exhausts this air through outlet 612.

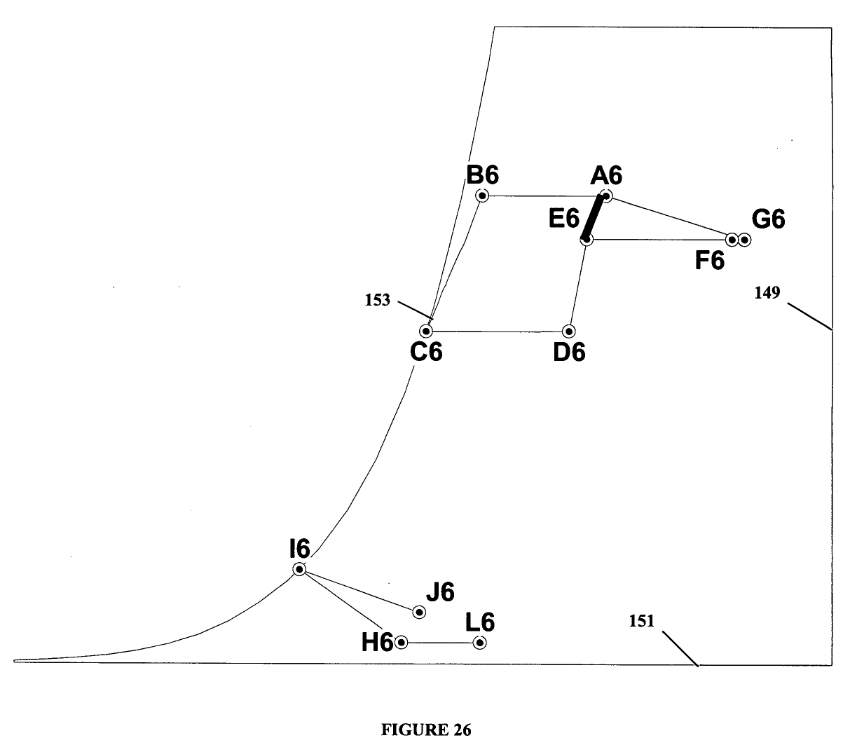

With reference to FIG. 26, there is shown a simplified psychrometric chart illustrating the thermal process illustrated be FIG. 25. In FIG. 26, the vertical axis 149 represents the absolute humidity content of water, weight of moisture per weight of dry air. The horizontal axis 151 represents the sensible temperature, measured in temperature units. The curve line 153 presents the saturation of air or gas, which means 100 percent relative humidity. Referring now to a first open path 614, H6 point corresponds to an ambient climate where the source of water vapor to produce potable water originates. This ambient air is pulled through an evaporative path spraying water to be filtered 16 and the sorption material with the change of vapor pressure causing sorption material to absorb and/or adsorb almost all the water vapor from the ambient air producing J6. Referring now to the closed loop regeneration second path 616, hot and relatively dry air G6 is pulled through sorption material and the change of vapor pressure rejects most of the water vapor to second path air stream. A percentage of the second path is re-circulated and mixed with cooler and drier air at E6 originating from the third path. Re-circulation of the second path realizes higher dew point temperatures, allowing for water generation in extremely arid climates, and increasing energy efficiency by decreasing condenser energy losses. Air or gas is then sensibly heated to F6 and re-heated by motor and movement of fan 642 to G6, which starts the cycle of the second path. Referring now to the closed loop regeneration third path 617, warm and very humid air A6 is sensibly cooled to point B6 with the possibility of reaching a temperature beneath the dew point whereby water precipitates from vapor to liquid stage. From B6, the third air path is further cooled to a temperature beneath the dew point whereby additional water precipitates from vapor to liquid stage at point C6. Liquid water is further treated and delivered for human consumption or cooling. The air or gas is now cool and with a lower absolute humidity level content than at A6, whereafter the mass of drier air is reheated to D6 and then mixed with the closed loop second air stream producing point E6. Referring now the open fourth path 618, H6 point corresponds to ambient climate air where it is sensibly heated to L6.

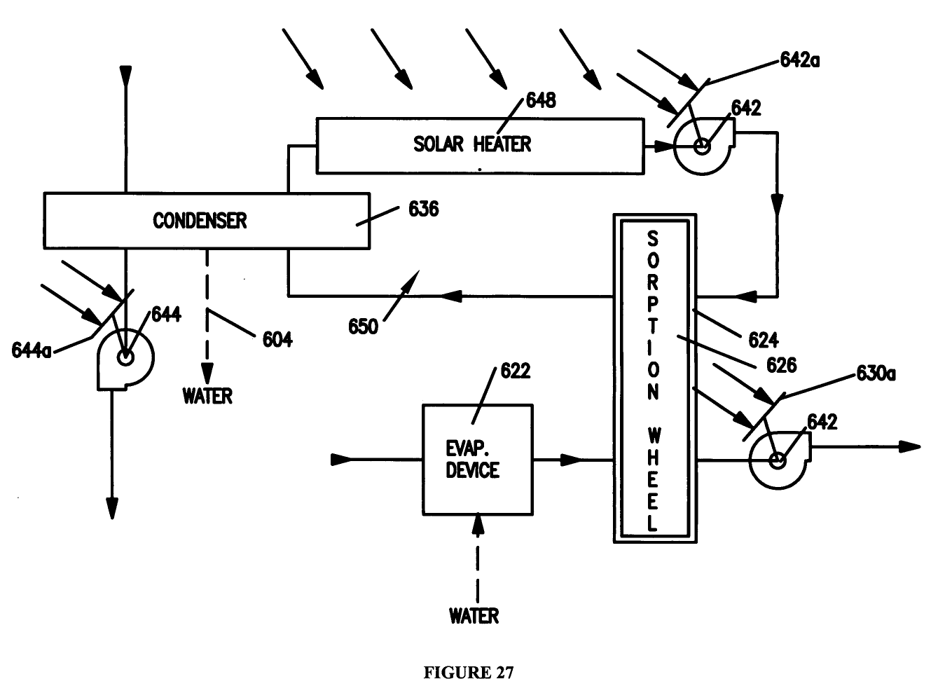

### ALTERNATIVES OF A SIXTH EMBODIMENT (FIGS. 27-29)

Referring now to FIG. 27, there is a schematic illustration of an alternative configuration of the sixth embodiment depicted by FIG. 25. Second closed-loop air path 616 and third closed-loop air path 617 have been combined into a single, second closed-loop air path 250, thus eliminating condenser bypass 632 and heat exchanger 634. Closed-loop air path 250 comprises portion of sorption wheel housing 624, condensing heat exchanger 636, solar heater 648, and fan 642. Solar heater 648 can be either a solar air heater or a solar water heater coupled to a hot water storage tank. Sorption material 626 can be made of a hygroscopic matrix coated with lithium chloride desiccant to provide very high absorptive and/or adsorptive properties and thus enable extremely low reactivation temperatures to be achieved. Fans can be powered through solar voltaic technology, using photovoltaic devices (solar cells) 642a, 630a, and 644a. Thus, an autonomous water filtering apparatus is realized.

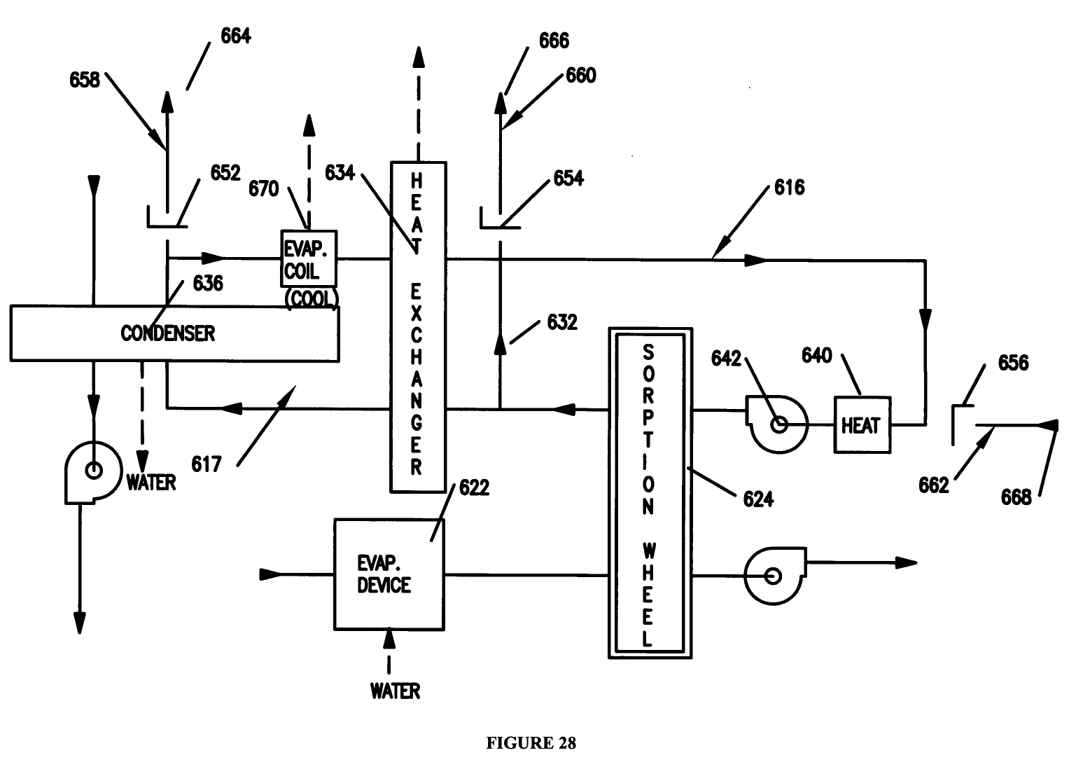

Referring now to FIG. 28, there is a schematic illustration of an alternative configuration of a sixth embodiment depicted by FIG. 25. Intake and exhaust paths have been added to closed-loop paths 616 and 617. Intake path 662 is added to closed loop 616 between condenser bypass 632 and heating device 640. Air or gas is drawn through outside air intake 668 creating a flow of fifth path air by means of suction provided by a fan 642 which further forces system input air 662 through a modulating damper 662 which controls flow rate. Exhaust path 658 is added to closed loop 617 between condensing heat exchanger 636 and condensing cooling device 670. Air or gas is drawn through exhaust 664 creating a flow of sixth path air by means of suction provided by a fan 642 which further forces system exhaust air 658 through a modulating damper 652 which controls flow rate. Exhaust path 660 is added after condenser bypass 632 and the mixing location of closed-loop paths 616 and 617. Air or gas is drawn through exhaust 666 creating a flow of seventh path air by means of suction provided by a fan 642 which further forces system exhaust air 660 through a modulating damper 654 which controls flow rate.

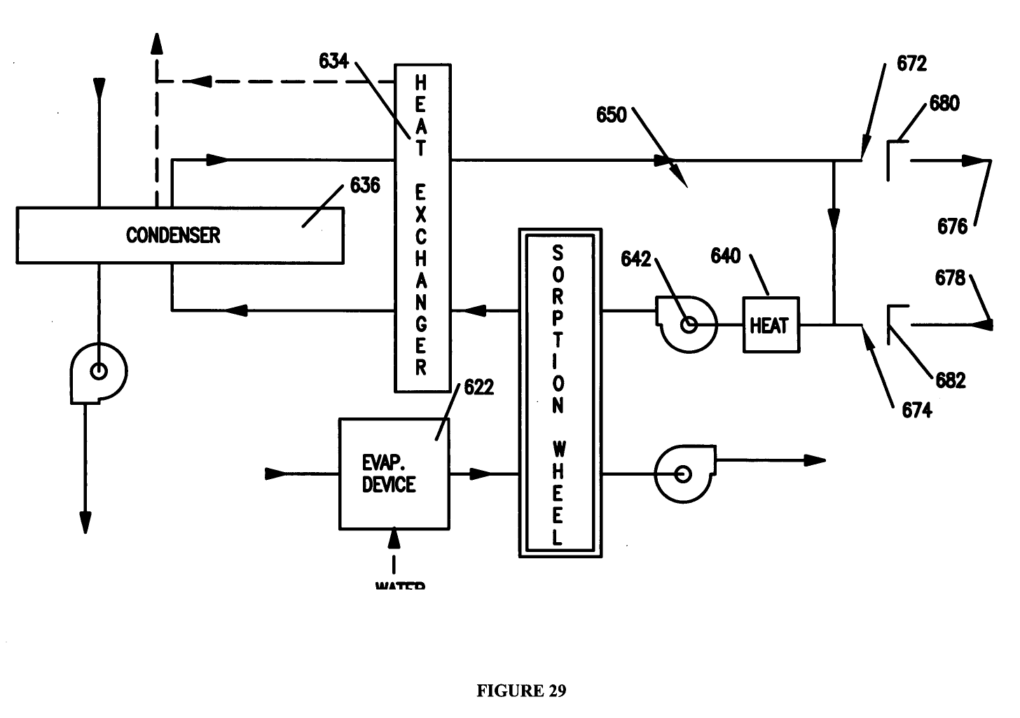

Referring now to FIG. 29, there is a schematic illustration of an alternative configuration of a sixth embodiment depicted by FIG. 25. Intake paths have been added to closed-loop path 650. Intake path 674 is added to closed loop 650 between heat exchanger 634 and heating device 640. Air or gas is drawn through outside air intake 678 creating a flow of fourth path air by means of suction provided by a fan 642 which further forces system input air 674 through a modulating damper 682 which controls flow rate. Exhaust path 672 is added to closed loop 650 between heat exchanger 634 and heating device 640. Air or gas is drawn through exhaust 676 creating a flow of fifth path air by means of suction provided by a fan 642 which further forces system exhaust air 672 through a modulating damper 680 which controls flow rate.

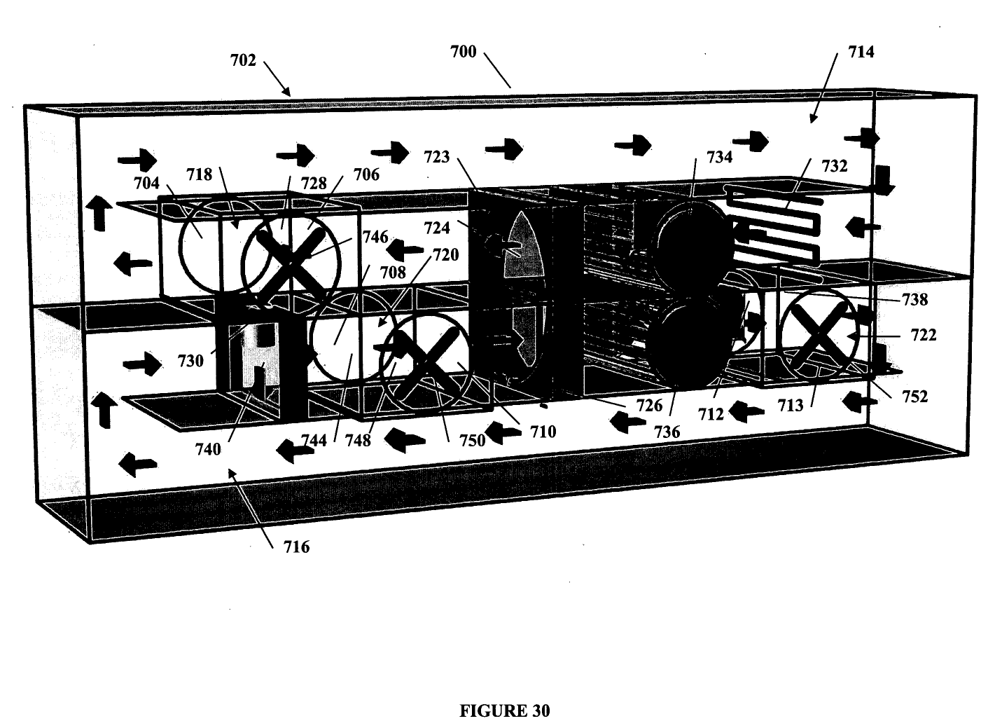

### DESCRIPTION OF A SEVENTH EMBODIMENT (FIGS. 30-35)

FIG. 30 illustrates an apparatus 700 that uses condensate water to cool an air stream 720 in accordance with a seventh embodiment of the subject invention. Apparatus 700 is contained within housing 702 which comprises condenser ambient air intake 704, condenser ambient air exhaust 706, process air intake 708, cooled process air exhaust 710, post desorption ambient air intake 712, post desorption ambient air exhaust 713. Housing 702 further contains five separate air paths: (1) a first path, closed-loop regenerative air path 714; (2) a second path, closed-loop cooling air path 716; (3) a third path, open condenser ambient air path 718; (4) a fourth path, process air path 720; and (5) a fifth path, an open post-desorption ambient air path 722. The first path 714 comprises portion of wheel housing 723 containing sorption material 724 (driven by sorption motor 726), condenser heat exchanger 728, condensate transfer tube 730 linking the two closed loops, heating source 732, and fan 734. The second path 716 comprises a portion of wheel housing 722 containing sorption material 724, fan 736, post desorption heat exchanger 738, evaporative device 740, condensate transfer tube 730 linking the two closed loops, and process air heat exchanger 744. The third path 718 comprises portion of condenser heat exchanger 728 and fan 746. The fourth path 720 comprises portion of process air heat exchanger 744 and fan 750. The fifth ambient open-air path 722 comprises post desorption heat exchanger 738 and fan 752.

### OPERATION OF A SEVENTH EMBODIMENT

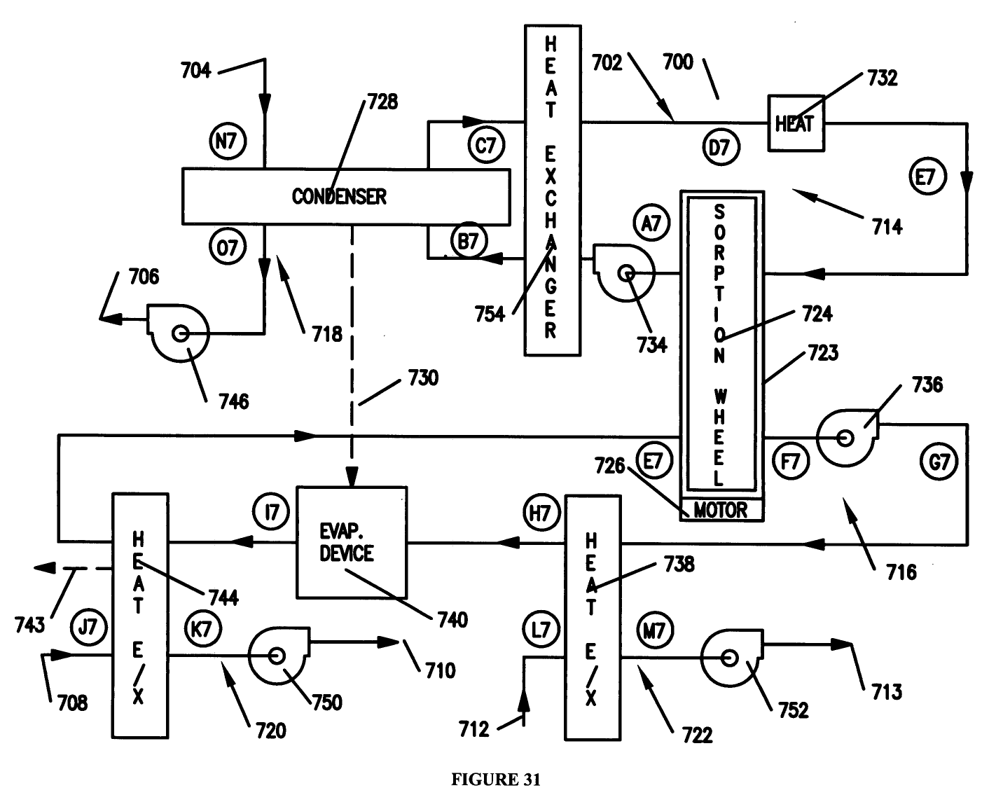

With reference now to FIGS. 30 and 31, the first path, closed loop regeneration path 714, is integrated and includes a regeneration fan 734 that re-circulates the hot and very humid air or gas through the first path 714. Hot and humid air is drawn by the pull effect of the fan 734 across the sorption wheel housing 723 and through the sorption material 724. This changes the vapor pressure of the desiccant contained in the sorption material 724 rejecting water vapor originating from the closed-loop second path into the first regenerative path. Air is drawn through a first heat exchanger 754 and pre-cooled. The heat exchanger can comprise heat pipes, plate-to-plate, rotary, or other types of heat exchangers. The first path air flow is then pushed through condenser 728, a heat exchanger that allows the further cooling of the air or gas to a temperature beneath the dew point through the use of an ambient temperature third path 718. The humidity content, or moisture, within pre-cooled air or gas within flow path 714, when crossing the condensing heat exchanger 728, condenses as a liquid condensate, and this liquid condensate is further drained out of the closed loop regeneration path 714 and delivered by condensate tube 730 back to the second closed-loop path. In this way, all water is recovered with no additional water being added to the system. The air stream within the first path 714 is now drier than immediately following sorption material 724. A reheating device 754 coupled to the precooling device then sensibly heats the airflow. This is followed by further heating by heating device 732. Heating device 732 may comprise solar heated hot water, solar heated air, solar voltaic electric heat, fossil fuels, and/or low-grade/temperature waste heat. At this point, the cycle starts again and is continuous and is in a closed loop path.

The second path 716 is integrated for purposes of providing cooling to a fourth air stream comprising a source of water vapor for the recycle water flow 730. Suction provided by a fan 736 creates a flow of second path air which further forces system airflow through a sorption wheel housing 723 containing sorption material 724. The change of vapor pressure causes sorption material to absorb and/or adsorb almost all the water vapor from a second closed-loop air stream. This hygroscopic sorption material can be shaped in the form of a wheel 724, which is continuously rotated by a motorized driving mechanism 726. Sorption material 724 can be made of a hygroscopic matrix coated with lithium chloride desiccant to provide very high absorptive and/or adsorptive properties and thus enable extremely low reactivation temperatures to be achieved. Very dry and warmed air after sorption material 724 is pulled by fan 736, which pushes air through a first heat exchanger 738 cooled by a fifth ambient temperature air path 722. A multitude of heat exchanger types could be used herein such as, but not limited to, heat pipes, plate-to-plate, and rotary heat exchangers. The second closed-loop air path is further pushed by fan 736 through an evaporative device 740 spraying water originating from a first closed-loop air path and delivered via tube 730. Water delivered to evaporative device 740 via gravity or pump. Saturated and cooled air passes through a second heat exchanger 744, cooling a fourth process air path. A multitude of heat exchanger types could be used herein such as, but not limited to, heat pipes, plate-to-plate, and rotary heat exchangers. At this point, the cycle starts again and is continuous and is in a closed loop path.

The third path, open ambient condensing path 718, is integrated to provide means to condense water through tube 730 without requiring refrigeration or compression techniques. Air in the third path is drawn through outside air intake 704 creating a flow of third path air by means of suction provided by a fan 746. Sensibly warmed air after passing through portion of condensing heat exchanger 728 is pulled by fan 746, which exhausts this air through outlet 706.

The fourth path, process air path 720, is integrated to provide means to reject cooling from system 700 without requiring refrigeration or compression techniques. The fourth path can be closed-loop or open as depicted in FIGS. 30 and 31. Air is drawn through intake 708 creating a flow of fourth path air by means of suction provided by a fan 750. The fourth path air path flow is then pulled through condenser 744, a heat exchanger that allows the further cooling of the air or gas to a temperature beneath the dew point through the effect of a cooler second closed-loop air path 716. The cooled air or gas 720, when crossing the condensing heat exchanger 744, condensates the humidity content and this liquid condensate is further drained in a liquid state out of the fourth path and delivered by condensate tube 743. This water can be used as feed water or makeup water for the second closed-loop air path or can be supplied as potable water. Sensibly cooled air after passing through portion of condensing heat exchanger 744 is pulled by fan 746, which exhausts this air through outlet 706.

The fifth path, open post-desorption ambient air path 722, is integrated to provide means to reject heat gained from a second closed-loop air path passing through sorption material 723. Air is drawn through intake 712 creating a flow of fifth path air by means of suction provided by a fan 752. The fifth air path flow is then pulled through heat exchanger 738, a heat exchanger that allows heat rejection of a second closed-loop path. Sensibly heated air after passing through portion of heat exchanger 738 is pulled by fan 752, which exhausts this air through outlet 713.

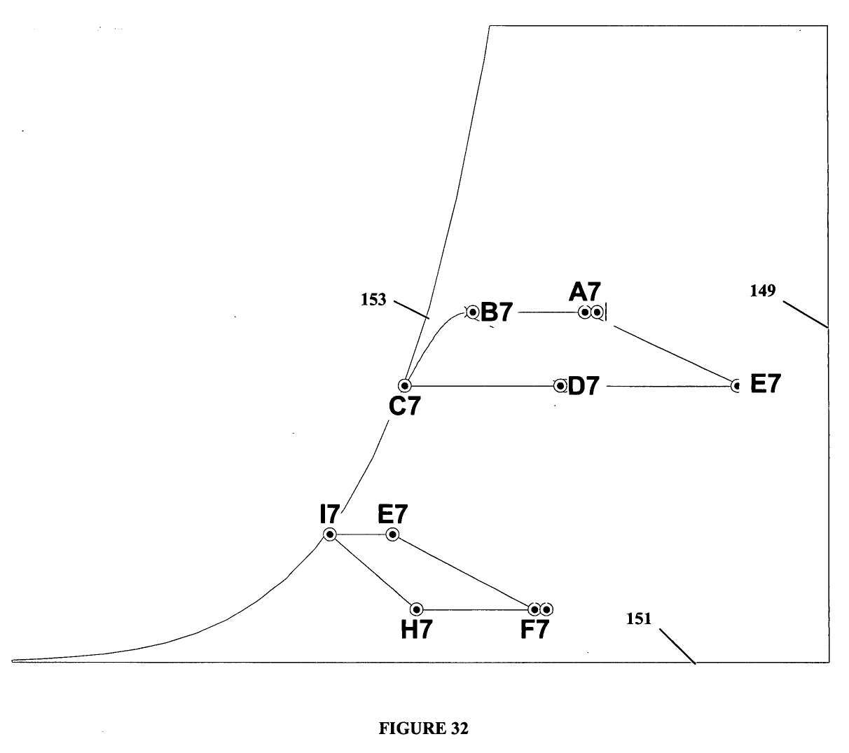

With reference to the FIG. 32, there is shown a simplified psychrometric chart illustrating the thermal process illustrated be FIGS. 30 and 31. In FIG. 32, the vertical axis 149 represents the absolute humidity content of water, weight of moisture per weight of dry air. The horizontal axis 151 represents the sensible temperature, measured in temperature units. The curve line 153 presents the saturation of air or gas, which means 100 percent relative humidity. Referring now to a closed loop regeneration first path 714, hot and relatively dry air E7 is pulled through sorption material and the change of vapor pressure rejects most of the water vapor originating from a second air stream to a first path air stream. Warm and very humid air A7 is sensibly cooled to point B7 with the possibility of reaching a temperature beneath the dew point whereby water precipitates from vapor to liquid stage. From B7, first air path is further cooled to a temperature beneath the dew point whereby additional water precipitates from vapor to liquid stage at point C6. Liquid water is transferred out of a first closed loop path and into a second closed loop path. Now air or gas is cool and with a lower absolute humidity level content than at A7 whereafter the mass of drier air is reheated to D7. Now air or gas is sensibly heated to E7, which starts the cycle of the first path. Referring now to a second closed loop path 716, very moist air E7 is pulled through the sorption material with the change of vapor pressure causing sorption material to absorb and/or adsorb almost all the water vapor from the second air path producing dry, warmed air F7. Dry and warm air F7 is sensibly cooled to point H7. Second closed loop path H7 is pulled through an evaporative path spraying water and is adiabatically cooled and humidified to 17, whereby spray water originates from first closed loop path. Second closed loop path 17 is heated to E7, whereby producing a cooling effect on a process air stream and completing the second closed loop path.

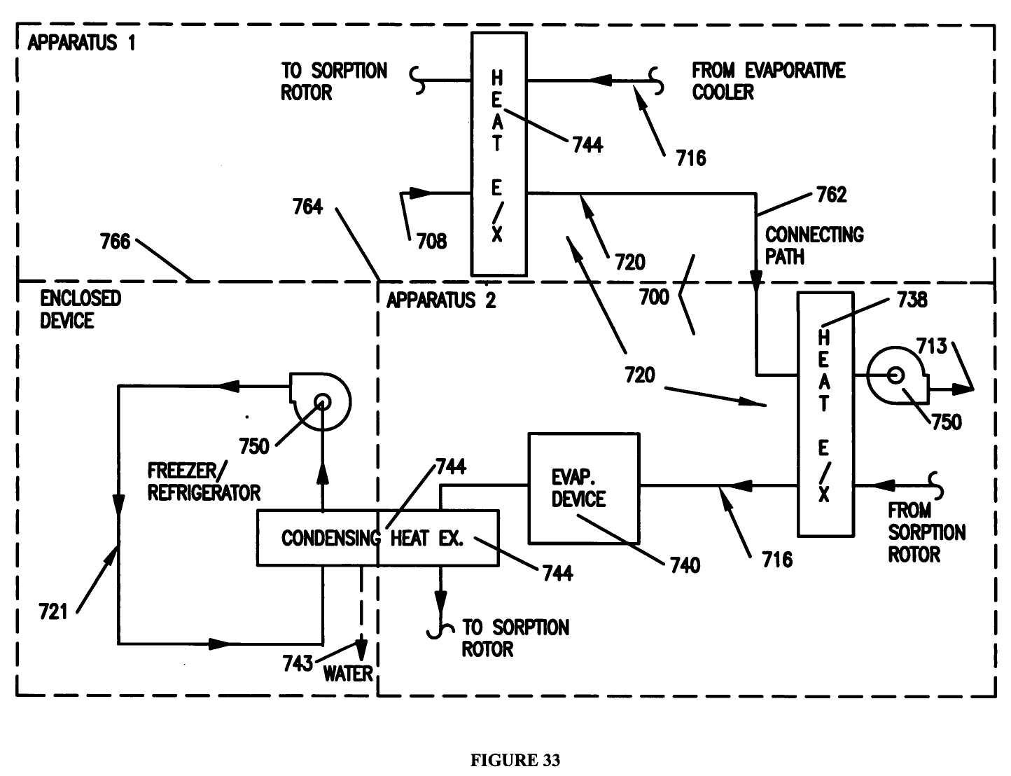

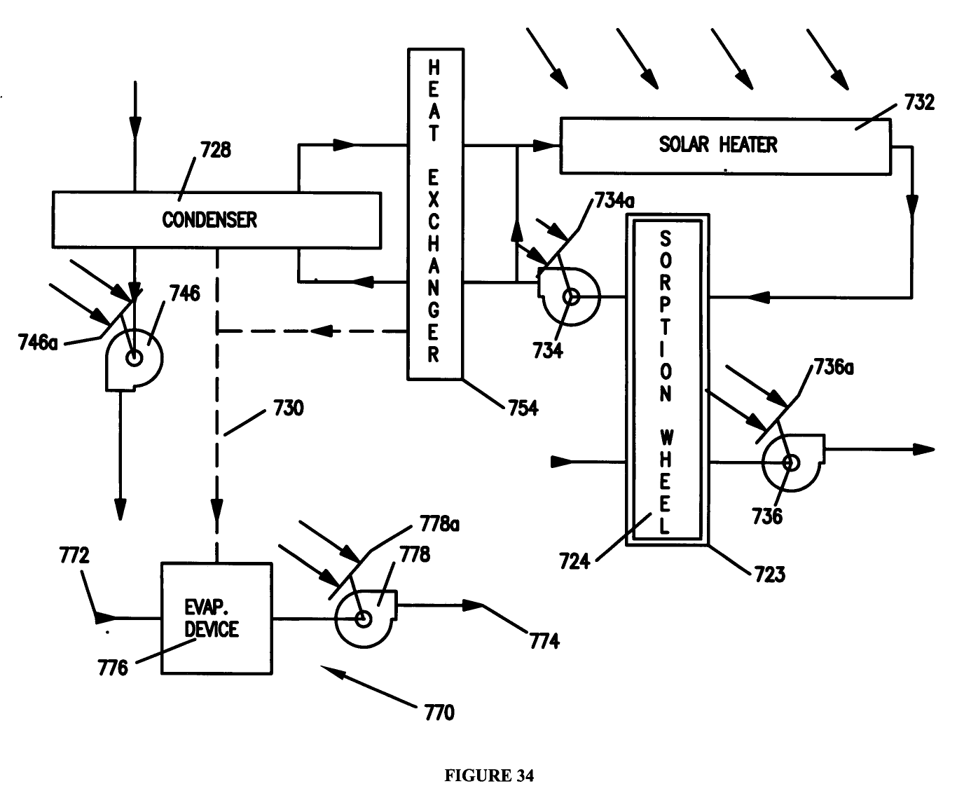

### ALTERNATIVES OF A SEVENTH EMBODIMENT (FIGS. 33-34)

Referring now to FIG. 33, there is a schematic illustration of an alternative configuration of a seventh embodiment depicted by FIGS. 30 and 31. Two or more cooling apparatuses 700, such as those described in the first embodiment and distinguished by dotted line 764, are joined by means of a common air path 762 connecting air path 720. In this way, a greater cooling potential is realized by cooling process air path 721. Cooling process air path 721 is further comprised of fan 750, machine or space needed to be cooled 766, and condensing heat exchanger 743. Device or space 766 can be, but is not limited to, applications such as frost-free freezers, frost-free refrigerators, building spaces, automobile interior, plane interior, and the like. Joined apparatuses 701 and 703 can provide cooling to a space or machine running completely off of the heating power of the sun. Heating device 758 is a solar air heater or a solar hot water coil. Sorption material 724 can be made of a hygroscopic matrix coated with lithium chloride desiccant to provide very high absorptive and/or adsorptive properties and thus enable extremely low reactivation temperatures to be achieved. System fans can be powered through voltaic solar cells 760. Thus, a completely autonomous cooling generating apparatus is realized running completely off of the power of the sun. Condenser bypass 756 can be used, creating two independent closed-loop paths.

Referring now to FIG. 34, there is a schematic illustration of an alternative configuration of a seventh embodiment. Open process air path 770 is cooled by means of an evaporative spraying water device 776 linked to a water-generating device described as a first embodiment. Process air path 770 is integrated to provide means to cool an air stream without requiring refrigeration or compression techniques. Open process air path 770 is drawn through outside air intake 772 creating a flow air by means of suction provided by a fan 778. Evaporative spraying water device 776 adiabatically cools and humidifies air path 770. Water is delivered by condensate path 730. Sensibly cooled process air path 770 is pulled by fan 778, which exhausts this air through outlet 774. Photovoltaic devices 734a, 736a, 746a, and 778a power fans 734, 736, 746, and 778 respectively.

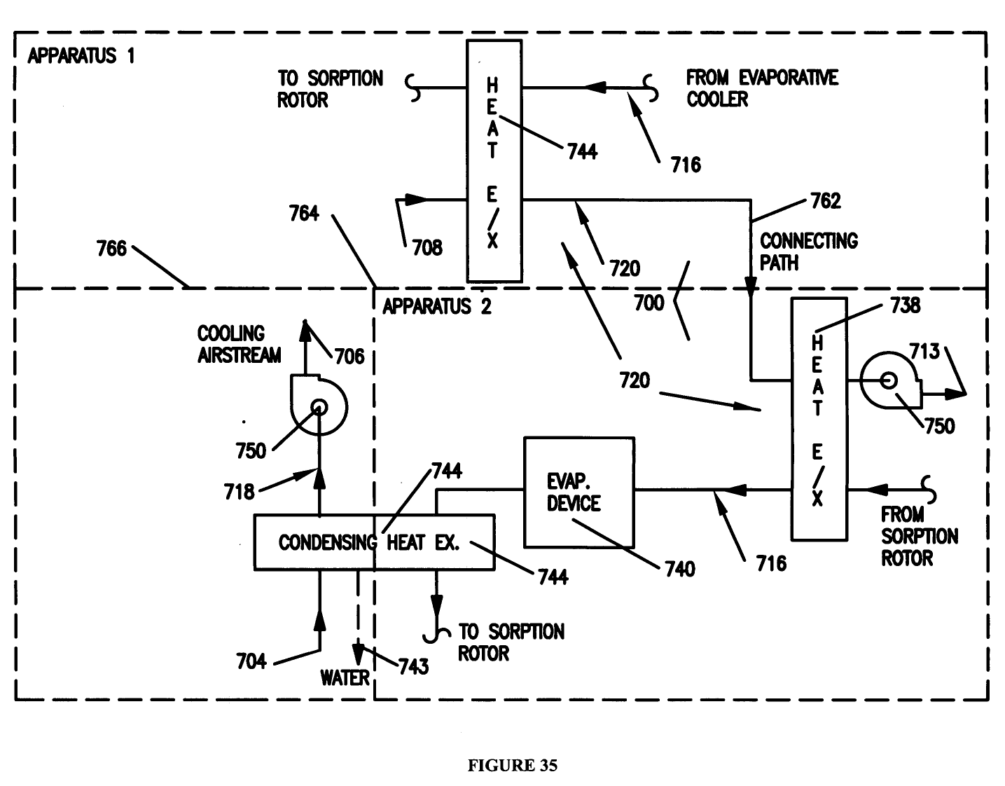

Referring now to FIG. 35, there is a schematic illustration of an alternative configuration of a seventh embodiment such as depicted by FIGS. 1, 2, 30, and 31. A water generating apparatus according to a first apparatus 100 is joined to a an apparatus according to a seventh embodiment 700 by means of common air path 780 connecting air paths 720 to 114 and 118. Dotted line 778 depicts the separation between apparatus 100 and apparatus 700. Apparatus 100, in this configuration, can now generate potable water from air even in extremely hot and extremely arid climates such as desert conditions. The combined machine depicted in FIG. 35 can generate potable water as an independent, autonomous device utilizing solar originating heat and solar voltaic.

### FURTHER EMBODIMENTS

Embodiments of the present invention can provide an economical source of potable water for human consumption, especially areas where no water resources exist or are not economically viable. As a possible solution to the world's humanitarian crisis for clean, safe drinking water, embodiments of the invention provide distilled water at much lower costs than previously realized by prior art.

Embodiments of the invention include methods of potable water generation in severely dry, arid climates where previous prior art technology could not operate. Apparatus according to the disclosed invention can economically produce significant quantities of potable water even in absolute humidity conditions below 6 grains of water vapor per pound of dry air (0.000857 lbv/lba), and can operate in relative humidity levels below 5 percent. It can also produce liquid water from ambient temperatures well below the freezing point.

Embodiments of the invention include filtration methods whereby existing, unsafe or contaminated water supplies are encouraged to evaporate with the water vapor being recovered in the form of distilled water. Evaporation can be achieved mechanically through such devices as evaporative spray nozzles or passively by allowing an air stream to pass over a body of water. The energy consumed in this process is much less than with traditional distillers and utilizes a much lower grade of heat (as low as 104° F.). The use of sustainable solar hot water or air collectors can be realized to perform the retrieval of water vapor from sorption material.

Drinking water can be provided in arid areas, opening them to human habitation and agriculture uses. Apparatus include self-contained, transportable, economical, environmentally friendly devices for the long-term generation of potable water for towns, villages, and cities.

Methods and apparatus according to the present invention can couple directly with a truck or automobile providing an instantly transportable source of water that can provide nourishment to its occupants or provide immediate disaster relief assistance. Waste heat rejected by a traditional internal combustion engine through the exhaust pipe, radiator, or engine compartment is realized as the primary energy source to generate potable water.

A small-scale bottled water plant can be constructed directly at the point of sale or consumption, eliminating the need for exorbitant transportation energy and costs associated with the relatively heavy weight of water. Hence, apparatus according to the present invention may further include a mechanism to direct liquid water into drinking bottles.

Energy can be obtained from solar energy (for example solar heat, thermoelectric generation, photoelectric solar cells) and electrically driven fans, an electrical grid connected with a plug, fossil fuels.

Method and apparatus according to the present invention allow for producing liquid water from ambient air using low energy input, and may be capable of autonomous operation. An easily portable unit may be transportable via a backpack or hand truck unit capable of producing distilled water from ambient air through autonomous operation using fossil fuels, batteries, solar heat, solar voltaic, or human work.

Apparatus and methods can provide a source of irrigation water for agriculture, livestock watering stations for remote areas where local water supplies are non-existent or unreliable, a source of distilled water for domestic household use in all areas, including arid climates, and/or a means of filtration or recycling of water from a household by means of adiabatic sprayers or other means of natural evaporation. As an alternative to current forms of irrigation, the invention provides salt-free water, thereby decreasing the salt-content in the soil and improving crop growing conditions and increasing growth rate.

Methods include a closed-loop, protective method for reducing susceptibility of growing microorganisms inside an apparatus for producing liquid water from ambient air.

Apparatus and methods can also be used for cooling, such as that done with an absorption chiller. An apparatus can operate off of the heat of the sun or other form of waste heat. This embodiment costs less to build and has a higher coefficient of performance than any current single effect absorption chiller. The device can also efficiently operate with temperatures lower than any currently available absorption chiller, for example at temperatures below 158° F. With the device operated with two closed loops, no external source of water is needed. The device can operate in any climate in the world with or without a water supply. No refrigerants or CFCs are required by the apparatus.

Embodiments of the invention include an evaporative cooling apparatus coupled with a device generating water from air through a closed loop sorption-desorption-condensation cycle. Therefore, no external source of water is needed and the device can operate in any climate throughout the world. Apparatus include a refrigerator or a freezer by which multiple desiccant evaporative cooling units are linked together to produce even cooler temperatures. A refrigerator and freezer can be powered by solar energy, such as solar heating.

Apparatus according to the invention can also provide a means for cooling the engine or occupants of a mobile vehicle, train, or plane. Liquid condensate produced from air can be allowed to evaporate within an engine resulting in a cooling effect. Two, closed cycle loops can provide air-cooling without the need for air intakes, radiators, or coils, thus improving the aerodynamic properties of a mode of transportation. Cabin and occupant cooling can also be accomplished via open or closed cycle adiabatic spraying of liquid condensate.

Apparatus according to the invention can also provides a means of total water recovery from a steam plant such as a nuclear reactor. In this example, heated steam is first used to reactivate the sorption wheel. The cooler steam is then absorbed into the desiccant wheel and further condensed at ambient temperatures. Thus, a backup or primary source of water would be available.

Example apparatus may comprise a bacterial killing heated sorption rotor, closed-loop recirculating air paths, and one or more ultraviolet light sources to reduce susceptibility to microorganisms.

Large airflow and sorption wheel exposure area ratios between first air path and second air path allow for a greater sorption of moisture from extremely arid climates, greater water flows, and higher energy efficiency. Multiple sorption rotors with multiple heating devices can be used in series within a closed-loop regeneration air path to increase moisture production.

Examples include an autonomous, transportable water generating device from air that is capable of running entirely off of the sun. Straps to an apparatus create a device that can be carried by a human. Both condensing heat exchangers and condensate tube can be vertically aligned so that water can easily be extracted, and the condensate tube can delivers water to the human mouth directly. A detachable solar air heating device can be unrolled by a person carrying it.

Examples of the present invention also include a water purifier. Evaporation of intake moisture can be passive, such as air blown over a pond or comprise an evaporative spray device. The water purifier can be entirely solar powered.

Examples of the present invention also include chillers, such as an apparatus comprising a sorption material rotor, evaporating device, condensing device, and a plurality closed loops. Apparatus may provide cooling of an air stream with only heat input, and may be capable of autonomous operation, running completely off solar power. Multiple apparatus may be configured in series, to produce colder air. Examples include a solar-, or heat-powered refrigeration system or freezer. Apparatus also include cooling devices for the intake of a micro turbine, powered by either waste heat or solar heat.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Patents, patent applications, or publications mentioned in this specification are incorporated herein by reference to the same extent as if each individual document was specifically and individually indicated to be incorporated by reference.

Having described our invention, we claim:

1. An apparatus for producing liquid water from water vapor in a source gas, the apparatus comprising:
a first flow path, through which the source gas flows;
a recirculating flow configuration through which a circulating gas flows, the recirculating flow configuration including a condenser and a heater; and
a moisture transfer device, transferring the water vapor from the source gas to the circulating gas,
the condenser cooling the circulating gas so that the liquid water condenses from the water vapor in the circulating gas,
the heater heating the circulating gas so as to increase water vapor uptake by the circulating gas from the moisture transfer device.

2. The apparatus of claim 1, wherein the recirculating flow configuration further comprises a condenser bypass, a fraction of the circulating gas passing through the condenser bypass instead of through the condenser.

3. The apparatus of claim 2, wherein the fraction of the circulating gas passing through the condenser bypass is adjustable.

4. The apparatus of claim 1, wherein the moisture transfer device comprises a hygroscopic element having a first portion exposed to the source gas and a second portion exposed to the circulating gas, the hygroscopic element being moveable so as to subsequently expose the first portion to the circulating gas.

5. The apparatus of claim 4, wherein the hygroscopic element is a sorption wheel comprising lithium chloride.

6. The apparatus of claim 1, wherein the recirculating flow configuration further includes a regeneration fan operational to induce circulation of the circulating gas around the recirculating flow configuration.

7. The apparatus of claim 1, wherein the first path comprises a source gas inlet, a fan, and a source gas outlet, the source gas entering the first flow path through the source gas inlet and being exhausted through the source gas outlet.

8. The apparatus of claim 7, wherein the source gas is ambient air.

9. The apparatus of claim 8, wherein the source gas outlet is located outdoors.

10. The apparatus of claim 8, wherein the circulating gas is air, the heater heating the circulating gas so that the circulating gas is warmer than the ambient air as the circulating gas passes over the moisture transfer device.

11. The apparatus of claim 1, wherein the condenser is a heat-exchanging condenser.

12. The apparatus of claim 11, wherein the heat exchanging condenser transfers heat from the circulating gas to a flow of ambient air.

13. The apparatus of claim 1, further comprising a water sterilizer, the water sterilizer destroying pathogens within the liquid water.

14. The apparatus of claim 13, wherein the water sterilizer comprises a UV radiation source, a water heater, or a chemical agent.

15. The apparatus of claim 1, wherein the heater is a solar heater, the apparatus being powered entirely by solar energy.

16. The apparatus of claim 1, the apparatus being supported by a vehicle, the heater receiving heat energy from a vehicle engine.

17. The apparatus of claim 16, wherein flow of the source gas through the first flow path is induced by vehicle motion.

18. The apparatus of claim 16, wherein the liquid water is used for engine cooling of the vehicle.

19. The apparatus of claim 1, wherein the moisture transfer device is a sorption wheel, the apparatus being supported by a vehicle and the sorption wheel being rotated by a vehicle engine.

20. The apparatus of claim 1, further comprising an evaporative cooler receiving the liquid water, the evaporative cooler being used to cool a cooling fluid.

21. The apparatus of claim 20, wherein the cooling fluid is an engine cooling fluid.

22. The apparatus of claim 20, wherein the cooling fluid is a flow of cooled air.

23. The apparatus of claim 1, the apparatus further comprising a housing, the housing having one or more straps attached thereto, and being configured to be carried by a person.

24. The apparatus of claim 23, the apparatus being configured to deliver liquid water orally to the person when the person carries the apparatus.

25. The apparatus of claim 1, wherein the condenser and the heater are part of a closed cycle refrigeration unit.

26. A solar-powered apparatus for producing liquid water from water vapor in ambient air, the apparatus comprising:
an ambient air flow path, comprising an ambient air inlet, an ambient air outlet, and a first fan inducing flow of the ambient air through the ambient air flow path;
a recirculating flow configuration, including a heater, a condenser, and a second fan inducing flow of a circulating gas around the recirculating flow configuration; and
a moisture transfer device, transferring the water vapor from the ambient air to the circulating gas,
the condenser cooling the circulating gas so that the liquid water condenses from the water vapor in the circulating gas,
the heater heating the circulating gas so as to increase water vapor uptake by the circulating gas from the moisture transfer device, the heater being a solar heater,
the first and second fan being powered by photovoltaic electrical energy,
the apparatus providing liquid water from the water vapor in the ambient air on receiving solar energy.

27. The apparatus of claim 26, wherein the moisture transfer device is a sorption wheel comprising lithium chloride.

28. The apparatus of claim 26, further comprising an evaporative cooler, the evaporative cooler receiving the liquid water and cooling a flow of cooling fluid.

29. The apparatus of claim 26, the cooling fluid being a flow of cooled air, the apparatus being a solar-powered air conditioner.

30. A method of producing liquid water from water vapor in air in an arid environment, the method comprising:
extracting water vapor from an air flow using a sorption wheel;
transferring the water vapor to a circulating gas within a recirculating flow configuration by rotating the sorption wheel; and
condensing the liquid water from the circulating gas using a condenser.

31. The method of claim 30, further comprising sterilizing the liquid water for human consumption.
